(19) United States
(12) Patent Application Publication
(10) Pub. No.: US 2014/0200313 A1
(43) Pub. Date: Jul. 17, 2014

(54) METHOD FOR PREPARING DIALKYL MAGNESIUM COMPOUNDS BY ETHYLENE POLYMERISATION AND USES THEREOF

(71) Applicants: Thomas Chenal, Villeneuve D'Ascq (FR); Andre Mortreux, Hem (FR); Marc Visseaux, Houplines (FR)

(72) Inventors: Thomas Chenal, Villeneuve D'Ascq (FR); Andre Mortreux, Hem (FR); Marc Visseaux, Houplines (FR)

(73) Assignee: UNIVERSITE DE LILLE 1 SCIENCE ET TECHNOLOGIES, VILLENEUVE D'ASCQ CEDEX (FR)

(21) Appl. No.: 14/234,185

(22) PCT Filed: Jul. 20, 2012
(86) PCT No.: PCT/FR2012/051738

§ 371 Date: Mar. 20, 2014

(30) Foreign Application Priority Data
Jul. 22, 2011 (FR) 1156723

(51) Int. Cl. C08F 255/02; C08G 85/00; C08F 236/08; C08F 110/02; C08F 236/06

(52) U.S. Cl. CPC C08F 255/02; C08F 110/02; C08F 236/06; C08F 236/08; C08G 85/004
USPC 525/309; 526/172; 526/134; 525/319; 525/314; 525/386; 525/382

(57) ABSTRACT

A process for the preparation by ethylene polymerization of at least one dialkyl magnesium compound of formula R—(CH₂—CH₂)ₙ—Mg—(CH₂—CH₂)ₘ—R′ in which R and R′, identical or different, represent aryl, benzyl, allyl or alkyl groups and in which the integers n and m, identical or different, represent average —CH₂—CH₂— chain formation numbers greater than 1, the process including a single stage of mixing the following components: at least one ligand or one ligand precursor, at least one rare earth salt, at least one dialkyl magnesium compound of formula R—Mg—R′, and ethylene, in a medium allowing contact between the components of the above mixture.

The invention relates to the preparation of dialkyl magnesium compounds by ethylene polymerization and uses thereof.

Polyolefins have become an essential raw material in our society, with production worldwide exceeding 100 million tonnes annually. The extent of their use can be explained by their excellent physical and chemical properties such as their mechanical strength, their flexibility as well as their chemical stability and their ability to be recycled.

Most polyolefins are produced by polymerization using a catalytic system. The first catalytic systems used were catalysts of the Ziegler/Natta type, comprising a complex containing a transition metal and an organometallic compound. Subsequently, the co-catalyst ZnEt₂ was added to this system in order to improve control of the molar mass of the polyolefins by means of chain transfer reactions on the zinc atom (Agouri E., Parlant C., Mornet P., Rideau J., Teitgen J. F., Makromol. Chem., 1970, 137, 229-243). The latest generation of catalytic systems involves an organometallic-type co-catalyst and a metallocene complex, containing a group 4 element (Ti, Zr, Hf) or a rare earth element (Sc, Y, lanthanides). As their salts or derivatives remain in a very small quantity in the polymer produced, these elements have the benefit of not being toxic and therefore not representing a risk to health or the environment.

According to the concept of Catalyzed Chain Growth (Gibson V. C., Science, 2006, 312, 703-704), the organometallic compound generally used in excess acts as a chain transfer agent, the latter growing on the metallocene complex involved. The reversibility of the exchange between the growing polymer chain and the organometallic compound is the key element of the process. Under favourable conditions arising from a judicious choice of metals and ligands with respect to the catalyst/transfer agent pair, the precise control of the length of the chain growing on the two metals is ensured: this leads to organometallic compounds bearing polymer chains of identical length that can be controlled as desired.

Among the polyolefins, polyethylene PE, a saturated aliphatic polymer originating from ethylene polymerization, constitutes a target of choice. However, it has the shortcoming of not adhering well to, or being incompatible with, certain materials due to its non-polar nature, preventing its use in certain fields. There is therefore a need to be able to prepare functionalized PEs, containing polar groups or chains in order to improve the physical properties such as adhesion, wettability, hardness, elasticity, mechanical strength and compatibilization, in order to improve the dispersion of PE additives such as pigments, protection agents, fabric softeners, fillers, or in order to improve miscibility with other polar polymers. For more than half a century, the preparation of modified PE therefore plays an important part in the polymers industry.

In 1991, Mortreux et al. on the one hand (WO9307180), and Pettijohn et al. (U.S. Pat. No. 5,109,085) on the other hand, developed the use of ^{Ra}Cp₂MCl₂Li(OEt₂)₂ as a pre-catalyst (^{Ra}Cp represents an optionally substituted cyclopentadienyl) in ethylene polymerization reactions, a compound which will be converted to a catalyst at the time of the polymerization reaction. This pre-catalyst, not available commercially, is obtained in several stages by reaction between a rare earth salt MX₃ such as neodymium chloride NdCl₃, an alkylating agent such as butyllithium and a ligand precursor such as pentamethylcyclopentadiene. In fact, a coordinating solvent such as an ether, tetrahydrofuran (THF), is necessary during the preparation and this solvent is incompatible with the polymerization. A drawback of the use of this pre-catalyst is therefore the difficulty of preparation and isolation. On the other hand, by the addition of another catalyst compatible with the presence of this pre-catalyst, a bimodal polymer was obtained (U.S. Pat. No. 5,182,244).

In 1996, Mortreux et al. (EP0736536; Pelletier J. F., Mortreux A., Olonde X., Bujadoux K. Angew. Chem. Int. Ed. Engl., 1996, 35, 1854-1856) described a process for preparing long-chain dialkyl magnesium compounds obtained from the abovementioned catalytic system and uses thereof in order to obtain functionalized PEs. In fact, these long-chain dialkyl magnesium compounds can be involved in Grignard-type reactions and thus provide polymers containing a lipophilic chain for example, or an alcohol, acid or silyl function. The drawback of this process is the use of pre-catalyst ^{Ra}Cp₂MCl₂Li(OEt₂)₂ in order to access the chain growth catalyst.

In 2002, the Bayer group (U.S. Pat. No. 0,077,433; U.S. Pat. No. 6,383,971) claimed a catalytic system comprising a rare earth salt combining with the metalloid a carboxylate, a cyclopentadiene derivative as ligand precursor and an alkylating agent which is not a dialkyl magnesium compound, for the polymerization of conjugated dienes, this system not being effective for PE preparation.

More recently, Mortreux et al. have described catalysts containing a rare earth element, combined with cyclopentadienyl-type ligands and with a magnesium, for the polymerization of styrene and isoprene (Zinck P., Valente A., Tether M., Mortreux A., Visseaux M. Comptes Rendus de l'Académie des Sciences Chimie, 2008, 11, 595-602; Visseaux M., Tether M., Mortreux A., Roussel P. Eur. J. Inorg. Chem., 2010, 2867-2876). The rare earth salt used is a borohydride, which makes it possible to work in non-coordinating solvents. The catalyst is either obtained in two stages with isolation of the pre-catalyst, or formed then used in situ, the two processes giving equivalent results in the case of the polymerization of isoprene and results that are very slightly unfavourable to the in situ process in the case of styrene. In the in situ process, it is easier to control the effect of the nature of the ligand.

In a general manner, the catalytic systems combining a pre-catalyst with a rare earth and an organomagnesium compound are well known for being very effective vis-à-vis the polymerizations of olefins, conjugated dienes, styrene or corresponding copolymerizations. Using such a pair, Mortreux et al. (Visseaux M., Terrier M., Mortreux A., Roussel P., Eur. J. Inorg. Chem., 2010, 2867-2876) have shown that the reaction is catalyzed by dimetallic active species formed by the combination of two ligands, the rare earth element and magnesium.

A mechanistic study has been carried out with the lanthanide borohydride of formula Ln(BH₄)₃, in the presence of tetrahydrofuran THF, a starting organomagnesium compound R—Mg—R′, and optionally substituted cyclopentadiene ^{Ra}Cp H as ligand precursor.

Mortreux et al. have shown that a combination is firstly formed between the rare earth salt and the starting magnesium compound. Then, one or two ligand equivalents react with this combination in order to provide the catalyst of the polymerization reaction. The catalytic complex is therefore a mixed organometallic derivative as it contains both a lanthanide, or more generally a rare earth, and magnesium.

The dialkyl magnesium compounds obtained by chain growth have the same reactivity as the Grignard-type reagents and can then be involved in functional modification reactions, making it possible to access a large number of functionalized long-chain compounds (Mazzolini J., Espinoza E., D'Agosto E, Boisson C., Polym. Chem., 2010, 1, 793-800).

A purpose of the invention is to provide a process for preparing dialkyl magnesium compounds by ethylene polymerization using a catalytic system in situ.

Another purpose of the invention is to provide an industrial-scale process for the manufacture of these functionalized PEs.

Another purpose of the invention is to obtain copolymers of ethylene and a polar or non-polar monomer.

Another purpose of the invention is to obtain long-chain alkanes, alcohols, acids, α-olefins, amines, thiols, azides, iodine derivatives or porphyrin dye or fluorescent rhodamine, by the use of the chemical properties of the long-chain magnesium compounds obtained by the polymerization, the latter being Grignard-type reagents.

Another purpose of the invention is to provide a novel process for preparing dialkyl magnesium compounds by ethylene polymerization, making it possible to avoid isolating the pre-catalyst constituted by a lanthanide salt bearing ligands, and defined hereafter.

According to a general aspect, a subject of the invention is the preparation by ethylene polymerization of at least one dialkyl magnesium compound of formula R—(CH₂—CH₂)ₙ—Mg—(CH₂—CH₂)ₘ—R′ in which R and R′, identical or different, represent cyclic or non-cyclic, substituted or unsubstituted, linear or branched aryl, benzyl, allyl or alkyl groups, comprising from 1 to 20 carbon atoms and in which the integers n and m, identical or different, represent average —CH₂—CH₂— chain formation numbers greater than 1, in particular from 20 to 200,

said process comprising a single stage of mixing the following components:
at least one ligand or one ligand precursor,
at least one rare earth salt of formula MX₃ in which M represents the rare earth element in the cationic form chosen from scandium, yttrium or the lanthanides and X the anion which is associated therewith,
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
and ethylene,
   in a medium allowing contact between the components of the above mixture,
   said contact allowing the formation of a catalyst between M, the magnesium and the ligand or the ligand precursor,
   said medium being compatible with ethylene polymerization, which leads to a polymerization product or mixture of products of formula R—(CH₂—CH₂)ₙ—Mg—(CH₂—CH₂)ₘ—R′ in which R, R′, n and m have the meanings given above.

The invention is based on a novel process for ethylene polymerization in the presence of a catalyst formed in situ, from a mixture containing a rare earth salt, a ligand or ligand precursor and the magnesium provided by a starting commercial organomagnesium compound, in particular chosen from butyl ethyl magnesium or di-n-hexyl magnesium.

By “polymerization”, is meant chemical reaction allowing polymer synthesis from active molecules called “monomers”. In the presence of the mixture of components referred to above and under the action of heat and pressure, macromolecular chains constituted by identical or different repeat units are thus formed.

The ethylene consumption remains constant until the growing alkyl chains reach a certain length. Starting from this length, the ethylene consumption increases substantially before falling. The number of growing chains is close to the number of C—Mg bonds. The dispersity of the chains, corresponding to the Mw/Mn ratio, is close to 1. Moreover, according to the temperature of the experiment, the chains can precipitate starting from a certain length. The reversible chain transfer on the magnesium is then less assured than in a homogeneous medium and the dispersity then increases significantly.

The expression “dialkyl magnesium compound” denotes a chemical compound comprising a magnesium atom and two magnesium-carbon bonds, “dialkyl” referring to the nature of the chains linked to the magnesium atom and formed by growth of the ethylene from the magnesium, said dialkyl chains being optionally terminated by an aryl, benzyl or allyl group. The average number of —(CH₂—CH₂)— chain formations of the two chains can be identical or different. The distribution of the quantities for each chain formation number depends on statistical laws governing the polymerization. In particular, when the polymerization is perfectly controlled, the distribution of the chain formation numbers follows Poisson's statistical law.

“Ligand” denotes a chemical species capable of forming a complex with the metal.

“Ligand precursor” denotes a chemical species capable of providing the ligand, corresponding to the definition indicated above, by deprotonation for example.

The number of “rare earth” type elements is 17: scandium ₂₁Sc, yttrium ₃₉Y, and the lanthanides comprising lanthane ₅₇La, cerium ₅₈Ce, praseodymium ₅₉Pr, neodymium ₆₀Nd, promethium ₆₁Pm, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu. They are used in a stable form in which their oxidation number is equal to +3. In the solid form of the salt, the M³⁺ cation is combined with three monocharged anions.

In this process, all the components are mixed in the reactor. It is not necessary to isolate the catalyst; it forms in the presence of the ethylene, with which it reacts as soon as it is formed, which is very fast compared with the rate of polymerization.

The catalyst is thus constituted by:
rare earth salt, in particular neodymium versatate, commonly used in the industrial production of elastomers, in which the anions are carboxylic acid derivatives of the “Versatic Acids” brand marketed by Shell, made up of a mixture of branched isomers of tertiary carboxylic acids with 10 carbon atoms,
starting dialkyl magnesium compound of formula R—Mg—R′, in particular the butyl ethyl magnesium compound commonly used in the industrial production of polyolefins,
one or more ligands or ligand precursors.

These three entities, rare earth salt, dialkyl magnesium compound and ligand(s) or ligand precursor(s), combine in order to form the “catalyst” which is active in the reaction medium vis-à-vis the ethylene polymerization reaction.

The expression “in a medium allowing contact” means that the species involved in this polymerization reaction provide favourable reaction conditions, leading to conversions of these species.

The expression “medium being compatible with the polymerization” means that the chosen species, reagents and components of the catalyst as well as the experimental conditions such as pressure and temperature, make it possible to carry out the polymerization reaction effectively. Furthermore, the process tolerates the presence of small quantities (1% to 20% in molar equivalents with respect to the dialkyl magnesium compound) of impurities usually considered poisonous to the rare earth-based catalysts, particularly oxygen, water and the protic acids, as these impurities are neutralized by a sacrificial part of the initial dialkyl magnesium compound, leaving intact the catalytic activity of the rare earth, just as many polymerization processes use excess methyaluminoxane (MAO) or excess trialkylaluminium, such as triethylaluminium, one role of which is to trap impurities.

According to an embodiment of the process of the invention, the ratio of the quantity of magnesium to the quantity of rare earth Mg/M is greater than 1 and in particular varies from 1 to 100,000 and is in particular chosen from 10 to 250, and in particular is equal to 50.

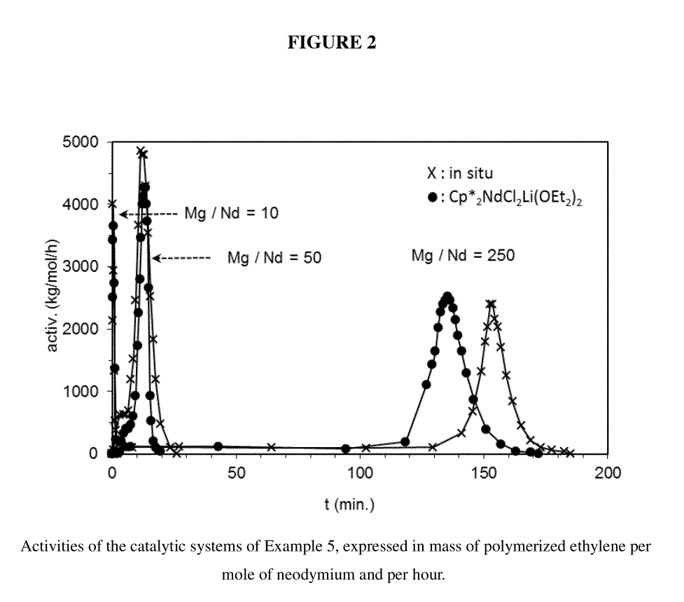

According to an embodiment of the process of the invention, the Mg/M molar ratio is greater than 1 and in particular varies from 5 to 100,000, and in particular from 10 to 250, and in particular from 50 to 100, and in particular is equal to 50.
Below the ratio 1, in particular in the case of the use of ligand precursors which require a deprotonation by two base equivalents in order to be converted to ligands, not enough alkyls are supplied by the magnesium to prepare the metallocene-type catalyst on the one hand and initiate the PE chains on the other hand. As can be seen in FIG. 2, for a low Mg/Nd ratio, the life span of the catalytic system is short. By contrast, for a high Mg/Nd ratio, the catalytic system is stable over a long period, although the activity is low during the first stage. Thus, there is really no upper limit for the Mg/Nd ratio, the only drawbacks being the slowness of growth of the chains and the viscosity resulting from the strong dialkyl magnesium compound concentration.

FIG. 2 shows the activities of the catalytic systems measured during two series of experiments, one mixing the salt Nd(BH₄)₃ and 2 equivalents of Cp*H in situ, the other using the pre-catalyst Cp*₂NdCl₂Li(OEt₂)₂ isolated beforehand. In each of the two series of experiments, the quantity of butyl ethyl magnesium was fixed with Mg/Nd ratios of 10, 50 and 250.

A stable activity can be observed if the quantity of magnesium compound is large (the larger the Mg/Nd ratio, the lower this activity in intensity but longer in duration).

A rapid and significant increase in activity is then observed, up to a value of 2500 to 5000 kg/mol/h, not very dependent on the quantity of magnesium compound, followed by deactivation of the catalytic system. In all the experiments, the reaction is stopped in the case of chain lengths substantially of the same order of magnitude. The masses of PE obtained are proportionate to the quantities of Mg involved and are similar between the two processes. Thus, the in situ process of the present invention makes it possible to access a catalytic system having substantially the same properties as the process using the pre-catalyst Cp*₂NdCl₂Li(OEt₂)₂ isolated beforehand.

In the presence of a large excess of magnesium compound, it unexpectedly turned out that polymerization had taken place. There was no indication that it would be the lanthanide that would be complexed by the cyclopentadienyle-type ligands. It was conceivable that it would be the magnesium that was the subject of this complexing in order to produce inactive (bis-cyclopentadienyl substituted)₂Mg-type complexes, the formation of which could were promoted by the excess of MgR₂, in which case the reaction would not have taken place.
According to an embodiment of the process of the invention, the components of the mixture are the following:
at least one ligand or one ligand precursor,
at least one rare earth salt of formula MX₃ in which M represents the rare earth element in the cationic form chosen from scandium, yttrium or the lanthanides and X the anion associated therewith,
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
at least one Lewis base chosen from the linear or cyclic ethers, crown ethers, and in particular diethyl ether or tetrahydrofuran, provided that the quantity of said base does not exceed 10 equivalents with respect to the quantity of magnesium compound,
and ethylene.

In the process of the invention, more than one ligand or ligand precursor, more than one rare earth salt, more than one starting dialkyl magnesium compound, and optionally a Lewis base such as an ether can optionally be used in the same reaction medium.

A “Lewis base” denotes a chemical species one of the constituents of which has one or more free or non-bonding electron pairs on its valence shell. It can therefore form coordinate covalent bonds with a Lewis acid. For example, the diethyl ether and the magnesium atom of a organomagnesium compound form a Lewis base/Lewis acid combination.

The use of a Lewis base is not systematic. But depending on the nature of X, and in particular if X is a halide, diethyl ether or tetrahydrofuran can be used in the reaction medium. This quantity of Lewis base should not be too large so as not to deactivate the catalyst. This is why this quantity of diethyl ether or THF must not exceed 10 equivalents with respect to the magnesium.

On the other hand, certain impurities, present and introduced with the products used, are Lewis bases, usually considered poisonous to the rare earth-based catalysts, particularly oxygen, water or the protic acids. This is the case for example with the versatic acid introduced at the same time as the versatate when the latter is used in the process. However, these impurities leave the catalytic activity of the rare earth intact as they are neutralized by a sacrificial part of the initial magnesium compound.

According to an embodiment of the process of the invention, the medium allowing contact between the components of the mixture contains a solvent or a mixture of solvents in which the components of the mixture are soluble or partially soluble, said medium and the solvent or mixture of solvents constituting the reaction medium.

The “solvent or mixture of solvents” denotes the chemical species capable of dissolving all or some of the components of the mixture in order to make contact between species possible. The mixture formed by the previously defined different components of the mixture and the solvent or mixture of solvents thus constitutes the “reaction medium” in which the formation of the catalyst and the polymerization reaction leading to the production of the polymers of formula R—(CH₂—CH₂)ₙ—Mg—(CH₂—CH₂)ₘ—R′ in which R, R′, n and m have the meanings given above, take place.

The expression “partially soluble” applies particularly to the catalyst, 1% of which in solution is sufficient to be able to carry out the polymerization, even if the reaction kinetics are then somewhat unfavourable.

According to a particular embodiment of the process of the invention, the components of the mixture contain halide ions chosen from Cl⁻, Br⁻ or I⁻.

The halide can be supplied by the rare earth salt, in particular MCl₃ and in particular NdCl₃.

According to a particular embodiment of the process of the invention, the components of the mixture do not contain the halide ions Cl⁻, Br⁻ or I⁻. The solubility of the components in the solvent or the mixture of solvents is greater in this case, which gives them better initial reactivity vis-à-vis the organomagnesium compound.

According to a particular embodiment of the process of the invention, in the rare earth salt of formula MX₃, X is different from Cl⁻, Br⁻ or I⁻. The solubility of the components in the solvent or the mixture of solvents is greater in this case.

According to a particular embodiment of the process of the invention, the components of the mixture contain an alkali element ion chosen from Li⁺, Na⁺, K⁺ or Cs⁺.

This cation can be supplied by a strong base such as butyllithium or by a ligand combined with an alkali such as ^{Ra}CpNa.

According to a particular embodiment of the process of the invention, the components of the mixture do not contain the alkali element ion Li⁺, Na⁺, K⁺ or Cs⁺.

According to a particular embodiment of the process of the invention, the components of the mixture contain neither Cl⁻, Br⁻ or I⁻ halide, nor alkali element ion Li⁺, Na⁺, K⁺ or Cs⁺.

According to a particular embodiment of the process of the invention, the components of the mixture contain a halide chosen from Cl⁻, Br⁻ or I⁻, and do not contain alkali element ion Li⁺, Na⁺, K⁺ or Cs⁺.

According to a particular embodiment of the process of the invention, the components of the mixture contain a halide chosen from Cl⁻, Br⁻ or I⁻ and contain an alkaline element ion chosen from Li⁺, Na⁺, K⁺ or Cs⁺.

According to an embodiment of the process of the invention, the reaction medium formed by:
at least one ligand or one ligand precursor,
at least one rare earth salt of formula MX₃ in which M represents the rare earth element in the cationic form chosen from scandium, yttrium or a lanthanide and X the anion associated therewith, X being different from Cl⁻, Br⁻, I⁻.
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
optionally at least one Lewis base chosen from the linear or cyclic ethers or crown ethers, and in particular diethyl ether or tetrahydrofuran, provided that the quantity of said base does not exceed 10 equivalents with respect to the quantity of magnesium compound,
ethylene,
solvent or a mixture of solvents,
catalyst,
polymerization products,
   is homogeneous.

The medium is “homogeneous” if all the components of the mixture are initially soluble in the solvent or the mixture of solvents used to carry out the polymerization reaction.

According to a particular embodiment of the process of the invention, when a Lewis base is present, it originates from the ligand and/or from the rare earth salt, and/or from the solvent or from the mixture of solvents.

The Lewis base can be an ether used to solubilize the salt MX₃ at the start. It can also be an impurity bound to the products used to carry out the polymerization. It can finally be a ligand intended to bind specifically to the dialkyl magnesium compound and therefore be a magnesium ligand, in particular when the Lewis base is a crown ether.

According to a particular embodiment of the process of the invention, the reaction medium is homogeneous from the abovementioned mixing stage up to the start of the precipitation of the polymerization products.

According to a particular embodiment of the process of the invention, the solvent or the constituents of the mixture of solvents are chosen from:
the linear, branched or cyclic alkanes comprising from 5 to 20 carbon atoms,
the aromatic compounds comprising from 5 to 20 carbon atoms, optionally substituted by linear, branched or cyclic alkyl groups comprising from 1 to 20 carbon atoms, these alkyl groups being optionally linked to another position on the same aromatic ring in order to form a side ring,
the halogenated compounds, in particular chlorobenzene, chloroform, dichloromethane, tetrachloromethane,
the free electron-pair donor compounds, in particular the linear or cyclic ethers or crown ethers, and in particular diethyl ether or tetrahydrofuran, provided that the quantity of these compounds does not exceed 10 equivalents with respect to the quantity of magnesium compound.

The mixture of solvents preferably contains an alkane, in particular hexane and heptane in which the butyl ethyl magnesium and the di-n-hexyl magnesium are commercial, and toluene which allows a solubilization of the rare earth salt that is partial or complete depending on the nature of X.

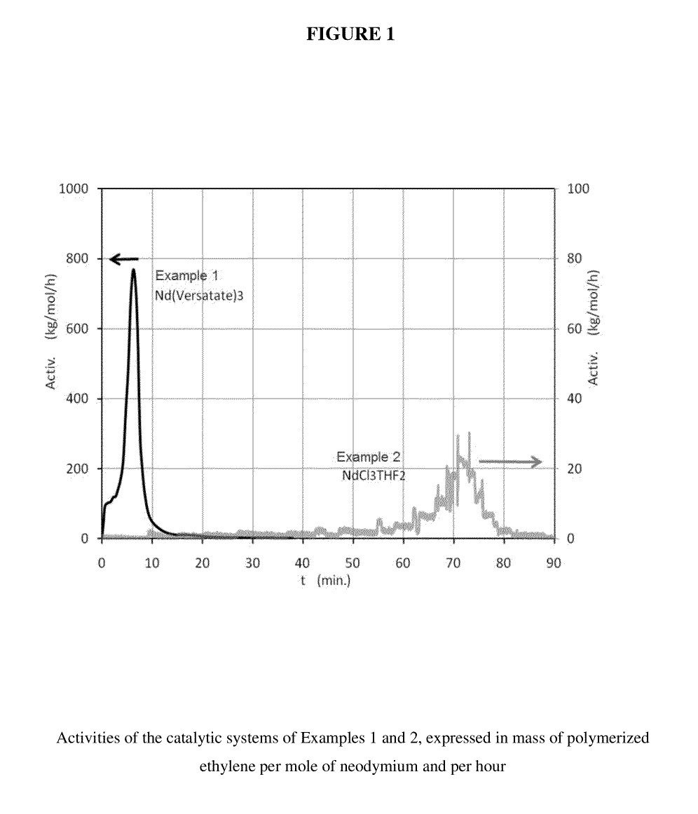

As shown by FIG. 1, the speed of the reaction depends on the solubility of the rare earth salt, therefore on the choice of the rare earth salt and on the choice of the solvent. Thus, if the activity obtained using neodymium versatate, Nd(versatate)₃, is compared with that obtained using neodymium chloride NdCl₃ and two equivalents of THF, the other parameters being identical, it is found that the maximum activity of the catalyst obtained from Nd(versatate)₃ is almost 800 kg of polymerized ethylene per mole of neodymium and per hour (kg·mol⁻¹·h⁻¹) compared with approximately 22 kg·mol⁻¹·h⁻¹ in the case of NdCl₃. In both cases, the mass of PE obtained is the same, if the same quantity of ethylene is consumed, adopting a longer reaction time with NdCl₃. The average length of the chains formed is the same: the mass of PE and the average length of the chains does not therefore depend on the choice of the rare earth salt.

According to an embodiment of the process of the invention, the ligand precursor has the formula ^{Ra}CpH in which ^{Ra}CpH represents an optionally substituted cyclopentadiene derivative of formula

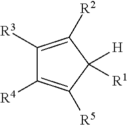

in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, moreover linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene.

The ligand precursor can be a compound which, by reaction with the other reagents of the catalytic mixture, in particular in the presence of dialkyl magnesium compound, is capable of forming a cyclopentadienyl anion ^{Ra}Cp⁻, optionally substituted by R¹ to R⁵ groups defined above, in particular the fulvenes.

The ligand precursor can also be an isoelectronic compound of a cyclopentadiene, or a compound capable of forming, by reaction with the other components of the reaction mixture, an isoelectronic analogue compound of a cyclopentadienyl anion, in particular the carboranes, tris(pyrazolyl)boranes, beta-diketones, beta-diimines, guanidines.

The following formulae represent certain ligands or ligand precursors, ^{Ra}CpH, used in the process of the invention.

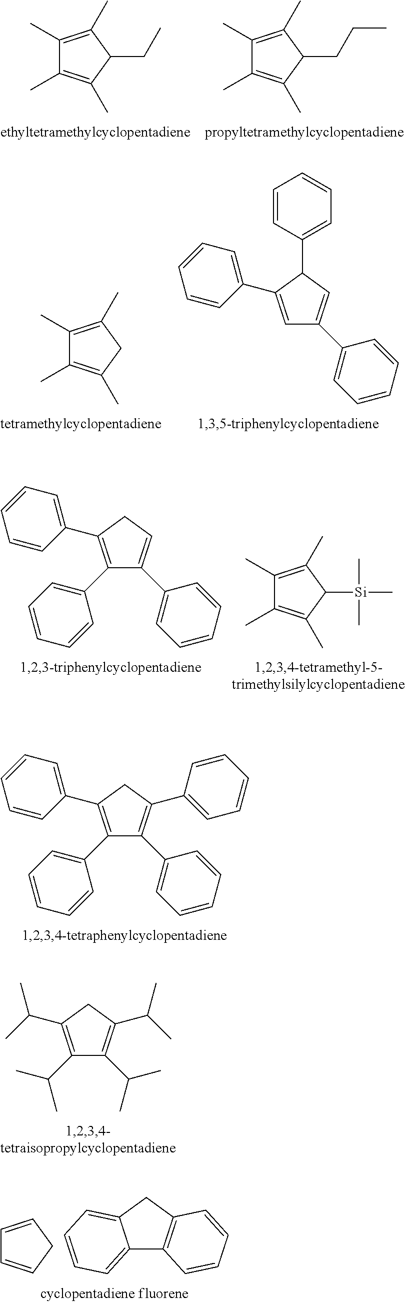

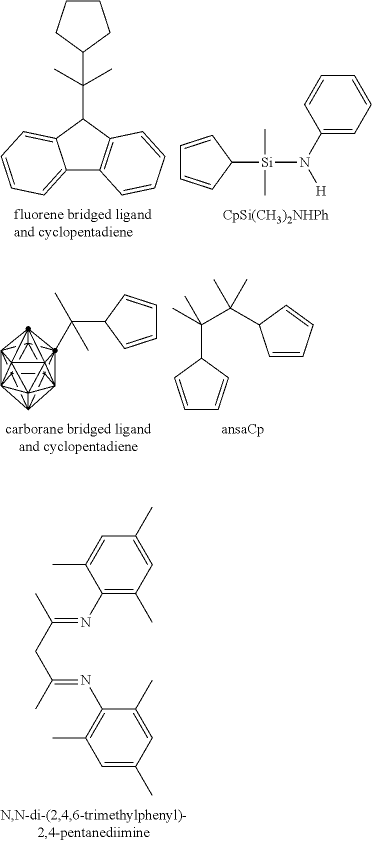

The quantity of ligand precursor ^{Ra}CpH varies from 1 equivalent with respect to the quantity of rare earth salt and 2 equivalents with respect to the quantity of dialkyl magnesium compound. The ^{Ra}CpH/MX₃ ratio is chosen preferably greater than or equal to 2 when a rare earth metallocene structure is desired.

Another particular case consists of choosing preferably the ^{Ra}CpH/MX₃ ratio equal to 1, in order to obtain either an ansa-metallocene or hemimetallocene structure, according to the structure of the chosen ligand precursor.

The term “metallocene” denotes a metal cation complex M with two ligands, in particular of the cyclopentadienyl-anion type, optionally substituted, for example M(^{Ra}Cp)₂.

The term “ansa-metallocene” denotes a metallocene the two cyclopentadiene-type parts of which are linked to each other by a bridge such as an aryl, silyl or alkyl chain as defined previously.

The term “hemimetallocene” denotes a metal cation complex M with a single cyclopentadiene-type ligand, in particular when the latter has a substituent the function of which, defined previously, also binds to the metal cation M.

According to an embodiment of the process of the invention, the catalyst obtained in situ between the rare earth salt MX₃, the dialkyl magnesium compound of formula R—Mg—R′ and the ligand precursor ^{Ra}CpH, is used without being isolated from the reaction medium, said catalyst being a metallocene or a hemimetallocene of the metal M combined with the magnesium by the R and R′ groups the meanings of which are given above.

In general, the pre-catalyst is isolated before being brought into contact with the starting magnesium compound and the olefin to be polymerized. In the process, the components of the mixture are introduced in a one pot process, thus simplifying the procedure. On the other hand, this can make it possible to facilitate the screening of the ligand or ligand precursor.

According to a particular embodiment of the process of the invention, either a single rare earth salt of formula MX₃ is used, in which M represents a rare earth element chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium ₆₁Pm, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu,

said element being found in the cationic form with an oxidation number +3,
or a mixture of salts of rare earth of formula MX₃ in which M has the meanings given above.

According to an embodiment of the process of the invention, the rare earth salt has the formula MX₃ in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatates, borohydride, or tert-butylate.

In particular use of the following is chosen:
X equal to the chloride,
X equal to the versatate, i.e. the mixture of anions derived from the branched isomers of tertiary carboxylic acids with 10 carbon atoms of the “Versatic Acids” brand marketed by Shell,
X equal to the borohydride BH₄⁻
X equal to the tert-butylate of formula

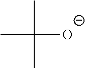

The rare earth salt MX₃ can optionally be accompanied by 1 to 10 equivalents of an adduct such as diethyl ether, tetrahydrofuran, pyridine, tributyl phosphate, lithium chloride and water. Other preferred adducts are the carboxylic acids, alcohols, phenols, amines, diketones.

The process for the in situ preparation of the catalyst allowing the synthesis of the long-chain dialkyl magnesium compounds is in particular applicable to lanthanide salts in particular the versatates, commercial products that are easier to access than the borohydrides which require prior synthesis.

According to a particular embodiment of the process of the invention, at least two rare earth salts of formula MX₃ are used, in particular didymium salt. Didymium salt contains a mixture of the elements praseodymium and neodymium.

According to an embodiment of the process of the invention, the temperature of the reaction medium varies from −78° C. to 200° C., and is in particular from 20° C. to 110° C., and in particular is equal to 90° C.

The temperature is chosen so as to optimize the performances of the polymerization reaction. This choice takes account of many parameters. It is sought to improve some of these (rate of polymerization, rate of exchange of alkyl chains with the transfer agent, solubility of the PE, viscosity, heat transfer, homogeneity of the medium) and to minimize others (secondary reactions such as β-H elimination, reductive coupling, deactivation of the catalyst by formation of a π-allyl, by dimerization or by decomposition of the cyclopentadienyl ligand). A compromise is therefore sought which justifies the choice of temperature.

According to an embodiment of the process of the invention, the reaction medium is saturated with ethylene over the duration of the reaction by feeding with ethylene, the ethylene pressure varying from 0.1 bar to 1,000 bar, in particular varying from 1 to 50 bar, and is in particular equal to 1.1 bar.

For low pressures, the kinetics are proportional to the pressure (order of reaction 1). Above 50 bar the speed no longer increases with the pressure. The benefit of working at very low pressure can be slowing down the rate of polymerization in order to better control the insertion of a few ethylene units into the dialkyl magnesium compounds. The benefit of working at very high pressure (towards 1000 bar) can be working without solvent in supercritical medium, which could be an advantage from an ecological point of view.

According to an embodiment of the process of the invention, the temperature and the length of the chains are such that at least one polymerization product precipitates, and the reaction then continues in a heterogeneous reaction medium.

According to a particular embodiment of the process of the invention, the reaction medium is formed by:
the ligand or ligand precursor,
the rare earth salt of formula MX₃ in which M represents the rare earth element in the cationic form chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium ₆₁Pm, samarium ₆₂Sm, europium ₆₃Eu, gadolinium ₆₄Gd, terbium ₆₅Th, dysprosium ₆₆Dy, holmium ₆₇Ho, erbium ₆₈Er, thulium ₆₉Tm, ytterbium ₇₀Yb, lutetium ₇₁Lu, and X the anion associated therewith,
a dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
ethylene,
   leading to the formation of a first catalyst and the polymerization products defined previously, and of a second catalyst that is non-soluble in said reaction medium, leading to the formation of polyethylene.

According to a particular embodiment of the process of the invention, in the catalytic system
the first catalyst is a metallocene or a hemimetallocene of the metal M combined with the magnesium by the R and R′ groups the meanings of which were stated previously,
the second catalyst comprises an organometallic compound and a compound of formula M′X′₄ in which M′ is a transition metal, and X′ is chosen from the halogens, the alkyl groups containing from 1 to 20 carbon atoms, the alkoxy groups containing from 1 to 20 carbon atoms and the aryl groups comprising from 6 to 10 carbon atoms,
   said catalysts being compatible and operating in parallel.

The second catalyst can be constituted by a Ziegler-Natta type catalyst, such as TiCl₄ in the presence of an organometallic compound.

This embodiment makes it possible to prepare bimodal molecular weight distribution polymers, the polymer being then described as “bimodal polymer”. There are thus two groups of molecules of different average molecular weights, which can be expressed by the existence of several peaks in the curve obtained by gel permeation chromatography (GPC).

This type of polymers makes it possible to combine the properties of each group of molecules in the same material. For example, high-mass polymers provide good mechanical strength whereas the low masses make it possible to retain good fluidity for the material at a high temperature which facilitates its use.

In order to obtain a bimodal polymer, it is possible to use two catalysts operating in parallel, each ensuring the production of a group of chains of different average lengths. These two catalysts must be compatible with each other, able to coexist and be active in the same medium.

According to an embodiment of the process of the invention, the reaction medium is heterogeneous due to the immobilization of at least one of the components of the mixture, ligand or ligand precursor, rare earth salt, dialkyl magnesium compound, on a solid support, said chosen support being a support based on silica, alumina, metal oxide, in particular Nd₂O₃ or CeO₂, metal salt, in particular MgCl₂, synthetic polymer, in particular polystyrene sulphonate, or natural polymer, in particular a polysaccharide, clay, zeolite, MOF (Metal Organic Frameworks), ceramics, nanotube of carbon, graphene.

According to a particular embodiment of the process of the invention, the reaction medium is heterogeneous due to the immobilization of the ligand or of the ligand precursor, on a solid support, said chosen support being a support based on silica, alumina, metal oxide, in particular Nd₂O₃ or CeO₂, metal salt, in particular MgCl₂, synthetic polymer, in particular polystyrene sulphonate, or natural polymer, in particular a polysaccharide, clay, zeolite, MOF (Metal Organic Frameworks), ceramics, nanotube of carbon, graphene.

According to a particular embodiment of the process of the invention, an additional stage is carried out, of adding at least one polar monomer to the polymerization products of formula R—(CH₂—CH₂)ₙ−Mg—(CH₂—CH₂)ₘ—R, R and R′ having the meanings defined previously, in order to obtain a block copolymer.

The term “copolymer”, as opposed to “homopolymer”, denotes a polymer comprising two different kinds of monomers. By this process, the copolymers formed and isolated after treatment of the dialkyl magnesium compounds and elimination of the magnesium, are block copolymers of formula

A-A-A-A-A-B-B-B-B-B

in which A and B represent the two repeat units, A originating from the ethylene (A=—(CH₂—CH₂)) and B originating from the polar monomer.

At the end of the ethylene polymerization, the end of each chain being linked to a magnesium atom, another polymerization can be started, in particular with a polar comonomer.

The polymer obtained therefore contains an apolar block, originating from the ethylene, and a polar block originating from the second monomer used, these two parts being covalently linked. The benefit of the copolymers lies in their physico-chemical and mechanical properties which combine those obtained for the corresponding homopolymers.

Furthermore, the addition of a small quantity of block copolymer in a mixture of homopolymers that are immiscible with one another, makes it possible to structure the phases and optimize the physical properties. The polar-apolar block copolymers therefore play a “compatibilizing agent” role making it possible to obtain more homogeneous structures, a role giving them a strong added value. The structures can be globules, tubes and sheets, of a size that is intermediate between nanometric and micrometric and are the analogues of micelles in liquids.

According to a particular embodiment of the process of the invention, an additional stage is carried out, of the addition of an olefin, in particular chosen from
the conjugated dienes, in particular butadiene, isoprene, myrcene or ocimene,
the alpha-omega-dienes, in particular 1,5-hexadiene,
the aromatic vinyl compounds, in particular styrene, paramethylstyrene, alphamethylstyrene,
the alpha-olefins, in particular propene, butene, hexene, and octene,
   said additional stage being carried out on the polymerization products of formula R—(CH₂—CH₂)ₙ—Mg—(CH₂—CH₂)ₘ—R, R, R′, n and m having the meanings given above, in order to obtain a copolymer.

The general formula of the copolymer obtained by successive polymerizations of the ethylene then of the butadiene is as follows:

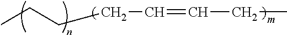

n having the meanings stated previously and m being from 1 to 10,000
Polyethylene-b-polybutadiene is obtained.

In the above and hereafter, “b” indicates a covalent bond between the blocks indicated on both sides, within each polymer chain.

The general formula of the copolymer obtained by successive polymerizations of the ethylene then of the isoprene is as follows:

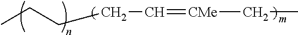

n having the meanings stated previously and m being from 1 to 10,000

Polyethylene-b-polyisoprene is obtained.

The general formula of the copolymer obtained by successive polymerizations of the ethylene then of the styrene is as follows:

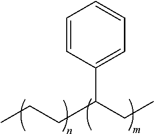

n having the meanings stated previously and m being from 1 to 10,000

Polyethylene-b-polystyrene is obtained.

According to a particular embodiment of the process of the invention, the polar monomer is chosen from the alkyl (meth)acrylates, (meth)acrylonitrile, the vinylpyridines, the lactones, the lactides, the lactames, the cyclic carbonates, the silsesquioxanes, the isocyanates, the epoxies, in particular methyl methacrylate, ε-caprolactone, L-lactide, ethylene carbonate.

For example, the general formula of the block copolymer obtained by successive polymerizations of ethylene then of methyl methacrylate is as follows:

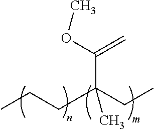

n having the meanings stated previously and m being from 1 to 10,000
in order to obtain polyethylene-b-poly-methyl methacrylate, PE-b-PMAM.

Another example is constituted by the general formula of the block copolymer obtained by successive polymerizations of ethylene then of ε-caprolactone:

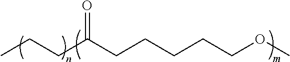

n having the meanings stated previously and m being from 1 to 10,000

in order to obtain polyethylene-b-poly-ε-caprolactone, PE-b-PCL.

The polar monomer polymerization stage is carried out either under the same reaction conditions as the ethylene polymerization stage, or by modifying the temperature, the pressure, purging the ethylene, adding an additional gas, an additional solvent, an additional catalyst, an additional ligand or an additional quantity of rare earth salt, the definitions of said solvent, catalyst, ligand and rare earth salt being those stated previously. These modifications are suited to the satisfactory implementation of the second stage of polymerization. The process then comprises a stage of hydrolysis or ethanolysis of the reaction products and a stage of recovery of the polar ethylene-comonomer diblock copolymer by filtration or by extraction.

According to a particular embodiment of the process of the invention, the mixture of components comprises:

a first ligand or ligand precursor of formula ^{Ra}CpH, in which ^{Ra}CpH represents an optionally substituted cyclopentadiene derivative, of formula

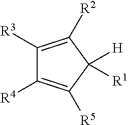

in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, in addition linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene,

a second ligand or ligand precursor of formula ^{Rb}CpH the meaning of which is the same as that given above for ^{Ra}CpH, provided that ^{Ra}CpH and ^{Rb}CpH are different,

at least one rare earth salt of formula MX₃, in which M represents a rare earth element chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium am, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu,

and in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatate, borohydride, or tert-butylate ion.

According to a particular embodiment of the process of the invention, the mixture of components comprises:

a first ligand or ligand precursor of formula ^{Ra}CpH, in which ^{Ra}CpH represents an optionally substituted cyclopentadiene derivative, of formula

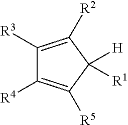

in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, moreover linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene,

a second ligand or ligand precursor of formula ^{Rb}CpH the meaning of which is the same as that stated above for ^{Ra}CpH, provided that ^{Ra}CpH and ^{Rb}CpH are different,

at least one rare earth salt of formula MX₃, in which M represents a rare earth element chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium am, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu,

and in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatate, borohydride, or tert-butylate ion,

at least one dialkyl magnesium compound of formula R—Mg—R′ in which R and R′, identical or different, represent cyclic or non-cyclic, substituted or unsubstituted, linear or branched aryl or alkyl groups, comprising from 1 to 20 carbon atoms,

ethylene,

a second olefin, in particular chosen from
the conjugated dienes, in particular butadiene, isoprene, myrcene or ocimene,
the alpha-omega-dienes, in particular 1,5-hexadiene,
the aromatic vinyl compounds, in particular styrene, paramethylstyrene, alphamethylstyrene,
the alpha-olefins, in particular propene, butene, hexene, and octene,
   and makes it possible to obtain, by the Chain Shuttling Catalysis process, long-chain dialkyl magnesium compounds the chains of which are copolymers of ethylene and another monomer chosen from the olefins named above.

The “Chain Shuttling Catalysis” process involves two different types of organometallic structures, for example rare earth metallocenes or hemimetallocenes, each being associated with a transfer agent which is common to them, for example the dialkyl magnesium compound. The catalytic polymerization system then operates by continuous transfer of the polymer chains between the two metallocene- or hemimetallocene-type structures, this mechanism generally being called “Chain Shuttling Catalysis”.

According to a particular embodiment of the process of the invention, the latter comprises one or more additional stages making it possible to prepare polyethylenes having a terminal function, in particular chosen from:
the primary linear fatty alcohols PE-OH obtained by oxidation, in particular with oxygen, of the polymerization products defined above,
the PE-CH═CH₂ α-olefins by thermal decomposition of the polymerization products defined above,
the PE-COOH acids, by reaction between CO₂ and polymerization products defined above,
the PE-SH thiols by a synthesis comprising three stages,
   a first stage comprising the preparation of the polymerization products defined above,
   a second stage comprising the manufacture of dithiocarbamate compounds by reaction between disulphiram (tetraethylthiuram disulphide) and the polymerization products obtained above,
   a third stage comprising the reduction of the dithiocarbamates obtained in the previous stage,
the iodine compounds PE-I by reaction between diiodine I₂ and polymerization products defined above,
the azides PE-N₃ by a synthesis comprising three stages,
   a first stage comprising the preparation of the polymerization products defined above,
   a second stage comprising the manufacture of an iodine compound by reaction between diiodine I₂ and the products originating from the polymerization obtained above,
   a third stage comprising the reaction of sodium azide with the iodine compounds formed in the second stage,
the amines PE-NH₂ by a synthesis comprising four stages,
   a first stage comprising the preparation of the polymerization products defined above,
   a second stage comprising the manufacture of an iodine compound by reaction between diiodine I₂ and the products originating from the polymerization obtained above,
   a third stage comprising the reaction of sodium azide with the iodine compounds formed in the second stage,
   a fourth stage comprising the reduction of the azides obtained in the third stage,
the colouring functions, in particular the PE porphyrin dyes by a synthesis comprising four stages,
   a first stage comprising the preparation of the polymerization products defined above,
   a second stage comprising the manufacture of an iodine compound by reaction between diiodine I₂ and the products originating from the polymerization obtained above,
   a third stage comprising the reaction of sodium azide with the iodine compounds formed in the second stage,
   a fourth stage comprising the reaction of the azides formed in the third stage with a porphyrin functionalized by an alkyne function in the presence of copper bromide (I),
the fluorescent “label” molecules, in particular of the rhodamine, PE-tagged type by reaction between the rhodamine B base and polymerization products defined above and of the following formula

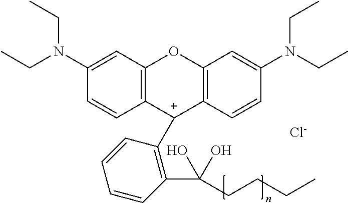

n having the meaning defined previously,
the PE-RAFT reversible addition and fragmentation transfer agents, in particular the compounds of the following general formula

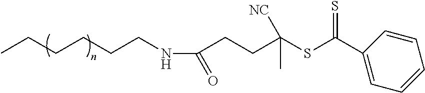

in which
n represents the average —CH₂—CH₂— chain formation number greater than 1, in particular from 20 to 200,
by reaction between amino-functionalized polymerization products PE-NH₂ defined above and the dithiocarbonyl product of the following general formula:

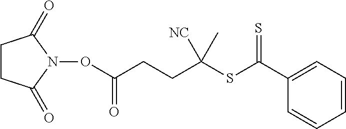

According to a particular embodiment of the process of the invention, primary linear fatty alcohols are manufactured by oxidation, in particular with oxygen, of the polymerization products of formula R—(CH₂—CH₂)ₙ—Mg—(CH₂—CH₂)ₘ—R, R and R′ having the meanings defined previously.

The dialkyl magnesium compounds obtained have chemical properties analogous to those of the Grignard reagents and react in particular with oxygen in order to produce long-chain alcohols according to the equation below:

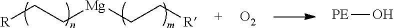

R, R′, n and m having the meanings stated previously
“PE-OH” means hydroxylated polyethylene in terminal position.

According to a particular embodiment of the process of the invention, on fabric in particular of the α-olefins by thermal decomposition of the polymerization products of formula R—(CH₂—CH₂)ₙ—Mg—(CH₂—CH₂)ₘ—R′, R and R′ having the meanings defined previously.

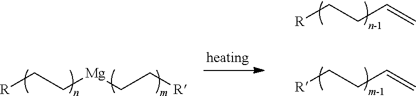

R, R′, n and m having the meanings stated previously

According to a particular embodiment of the process of the invention, acids are manufactured by reaction between the CO₂ and polymerization products of formula R—(CH₂—CH₂)ₙ—Mg—(CH₂—CH₂)ₘ—R, R and R′ having the meanings defined previously.

The reaction of the long-chain dialkyl magnesium compounds with carbon dioxide leads to carboxylic acids according to the following equation:

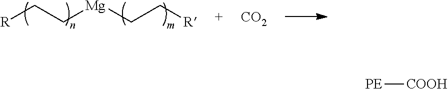

R, R′, n and m having the meanings stated previously
“PE-COOH” means polyethylene bearing a carboxylic group in terminal position.

According to a particular embodiment of the process of the invention, thiols are manufactured by a synthesis comprising three stages,
a first stage comprising the preparation of the polymerization products of formula R—(CH₂—CH₂)ₙ—Mg—(CH₂—CH₂)ₘ—R′, R, R′, n and m having the meanings defined previously,
a second stage comprising the manufacture of dithiocarbamate compounds by reaction between the disulphiram (tetraethylthiurame sulphide) and the polymerization products obtained above,
a third stage comprising the reduction of the dithiocarbamates obtained in the previous stage,
   in order to obtain thiols.

According to a particular embodiment of the process of the invention, iodine compounds are manufactured by reaction between the diiodine I₂ and polymerization products of formula R—(CH₂—CH₂)ₙ—Mg—(CH₂—CH₂)ₘ—R′, R and R′ having the meanings defined previously.

The reaction of the long-chain dialkyl magnesium compounds with the diiodine leads to terminal iodine derivatives according to the following equation:

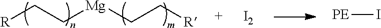

R, R′, n and m having the meanings stated previously
“PE-I” means polyethylene bearing an iodine atom in terminal position.

According to a particular embodiment of the process of the invention, azides are manufactured by a synthesis comprising three stages,
a first stage comprising the preparation of the polymerization products of formula R—(CH₂—CH₂)ₙ—Mg—(CH₂—CH₂)ₘ—R′, R and R′ having the meanings defined previously,
a second stage comprising the manufacture of an iodine compound by reaction between the diiodine I₂ and the products originating from the polymerization obtained above,
a third stage comprising the reaction of sodium azide with the iodine compounds formed in the second stage,
   in order to obtain azides.

PE-I previously obtained is modified by reaction with sodium azide in order to produce long-chain azides according to the reaction sequence represented in the following diagram:

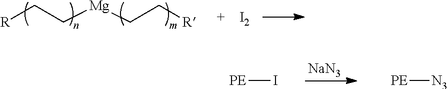

R, R′, n and m having the meanings stated previously
“PE-N₃” means polyethylene bearing an azide function in terminal position.

According to a particular embodiment of the process of the invention, amines are manufactured by a synthesis comprising four stages,
a first stage comprising the preparation of the polymerization products of formula R—(CH₂—CH₂)ₙ—Mg—(CH₂—CH₂)ₘ—R′, R and R′ having the meanings defined previously,
a second stage comprising the manufacture of an iodine compound by reaction between the diiodine I₂ and the products originating from the polymerization obtained above,
a third stage comprising the reaction of sodium azide with the iodine compounds formed in the second stage,
a fourth stage comprising the reduction of the azides obtained in the third stage,
   in order to obtain amines.

Previously obtained PE-I is modified by reaction with sodium azide in order to produce long-chain azides subsequently reduced to amines according to the reaction sequence represented in the following diagram:

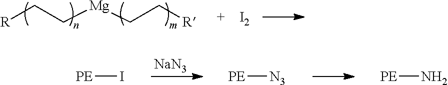

R, R′, n and m having the meanings stated previously
“PE-NH₂” means polyethylene bearing an amine function in terminal position

According to a particular embodiment of the process of the invention, polyethylenes functionalized by a porphyrin are manufactured, comprising four stages,
a first stage comprising the preparation of the polymerization products of formula R—(CH₂—CH₂)ₙ—Mg—(CH₂—CH₂)ₘ—R′, R and R′ having the meanings defined previously,
a second stage comprising the manufacture of an iodine compound by reaction between the diiodine I₂ and the products originating from the polymerization obtained above,
a third stage comprising the reaction of sodium azide with the iodine compounds formed in the second stage,
a fourth stage comprising the reaction of the azides formed in the third stage with a porphyrin functionalized by an alkyne function in the presence of copper bromide (I),
   in order to obtain polyethylenes functionalized by a porphyrin.

The terminal azide previously obtained reacts with a porphyrin bearing an alkyne function in the presence of CuBr according to the following equation:

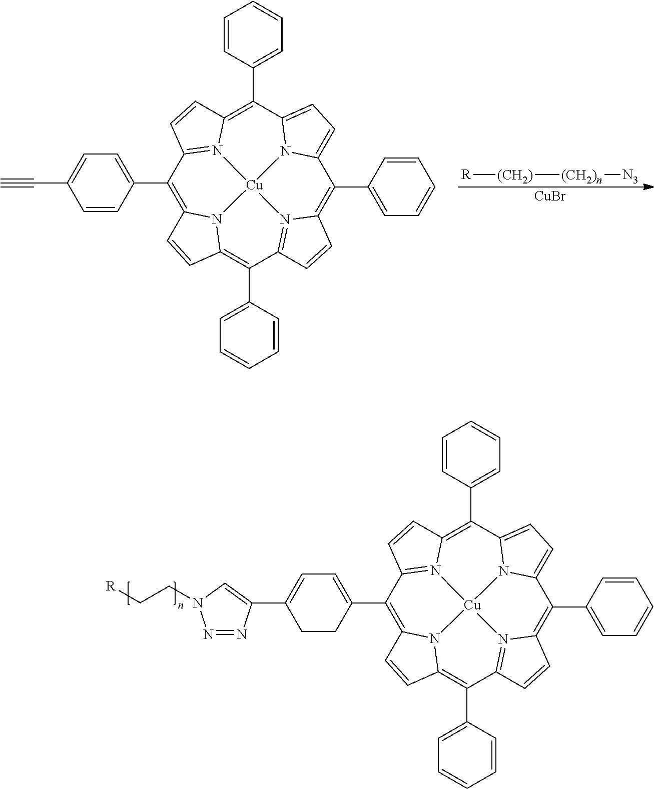

“PE-Dye”, polyethylene bearing a porphyrin group in the terminal position, is obtained.

According to a particular embodiment of the process of the invention, polyethylenes functionalized by a fluorescent rhodamine are manufactured, by reaction between the rhodamine B base (solvent red 49) of the following formula:

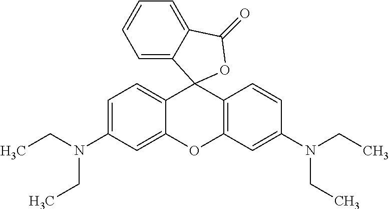 [SMILES: CCN(CC)c1ccc2c(c1)Oc1cc(N(CC)CC)ccc1C21OC(=O)c2ccccc21]

and polymerization products of formula R—(CH₂—CH₂)ₘ—Mg—(CH₂—CH₂)ₘ—R′, R and R′ having the meanings defined previously, in order to obtain “PE-Tag”, polyethylene bearing a fluorescent rhodamine group in the terminal position.

According to a particular embodiment of the process of the invention, the PE-NH-RAFT compound of the following general formula is manufactured:

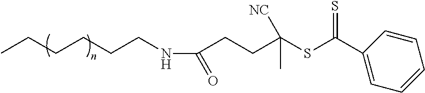

in which
n represents the average —CH₂—CH₂— chain formation number greater than 1, in particular from 20 to 200,
   by reaction between amino-functionalized polymerization products PE-NH₂ defined above and the dithiocarbonyl product of the following general formula:

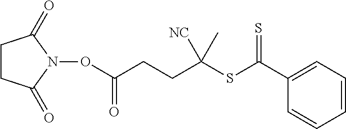

The dithiocarbonyl product is prepared by reaction between 4-cyano-4-(thiobenzoylthio)pentanoic acid and N-hydroxysuccinimide in the presence of dicyclohexylcarbodiimide (Briquet R., Mazzolini J., Le Bris T., Boyron O., Boisson E, Delolme E, D'Agosto E, Boisson C., Spitz R., Angew. Chem., 2008, 47(48) 9311-9313.

According to a particular embodiment of the process of the invention, copolymers are manufactured according to a RAFT-type procedure by reaction between PE-NH-RAFT compound and n-butyl acrylate (nBuA), in order to obtain an n-butyl polyethylene-b-polyacrylate copolymer. The assembly is carried out by an amide bond.

Among the different polymerization techniques, RAFT polymerization (polymerization by Reversible Addition-Fragmentation Transfer) is the most versatile technique and is currently the subject of significant research. It makes use of transfer agents called “RAFT agents” having a thiocarbonylthio group, such as that formed in the process.

The use of RAFT agents bearing functional groups allows the synthesis of functionalized polymers at the end of the chain.

FIG. 1 represents the activity of the system of Example 1 (black curve) and the activity of the system of Example 2 (grey curve). It is expressed in mass of polymerized ethylene per mole of neodymium and per hour, as a function of time expressed in minutes.

FIG. 2 represents the activity of the systems of Example 5, expressed in mass of polymerized ethylene per mole of neodymium and per hour, as a function of time expressed in minutes.

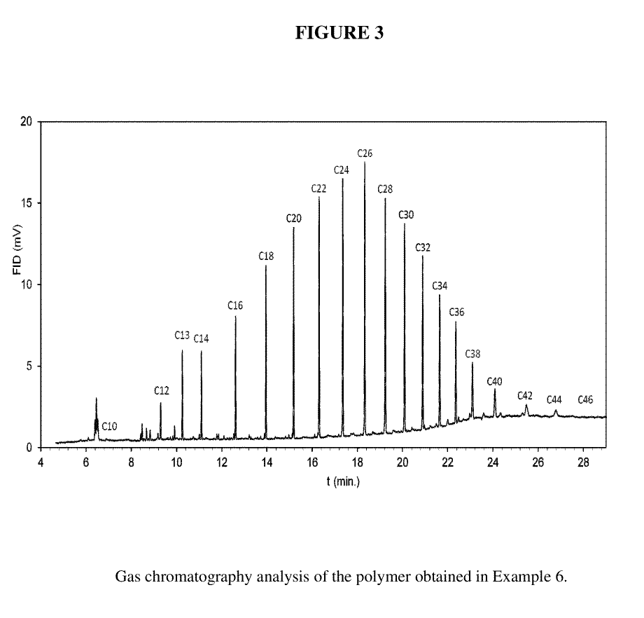

FIG. 3 represents the chromatogram obtained by gas chromatography of the polymer of Example 6.

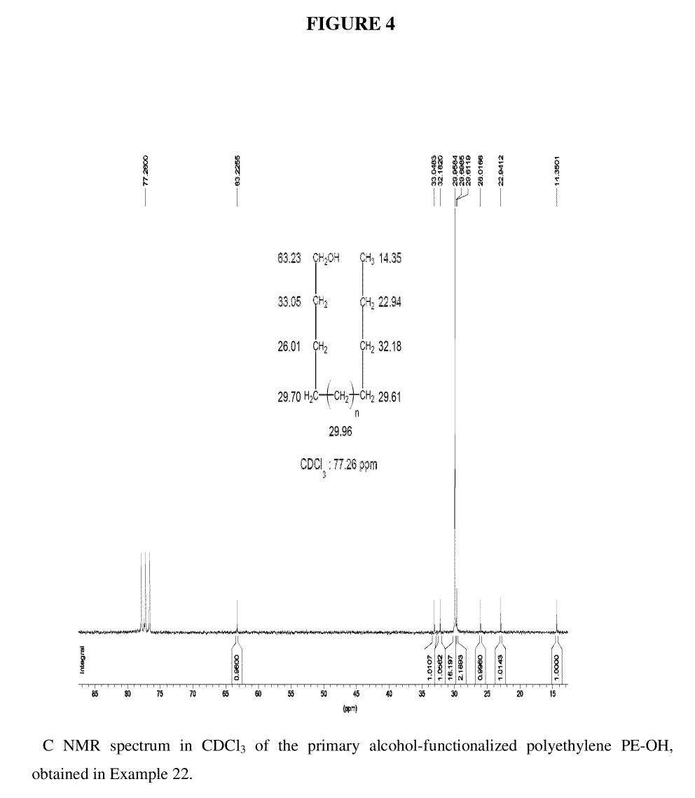

FIG. 4 represents the ¹³C NMR spectrum in CDCl₃ of the primary alcohol-functionalized polyethylene.

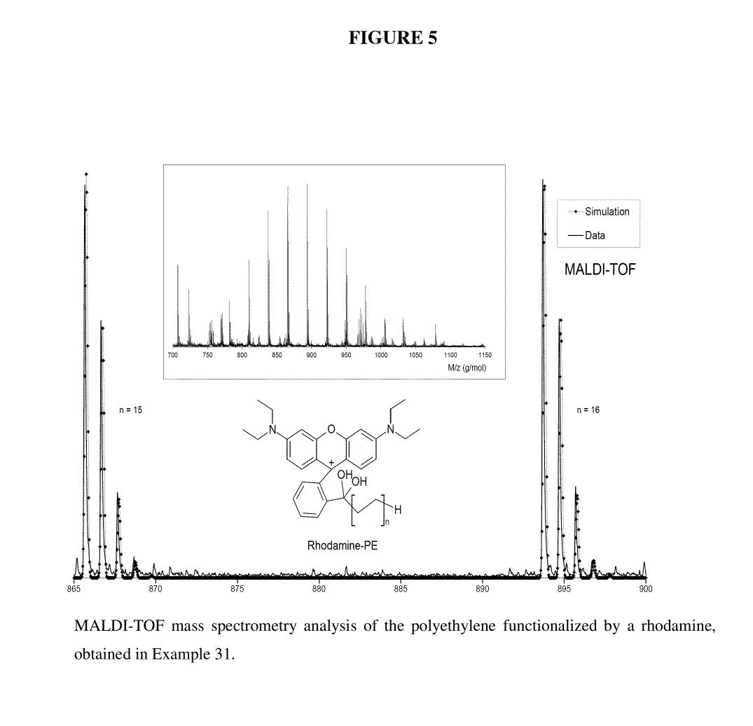

FIG. 5 represents the MALDI-TOF mass spectrometry analysis of the polyethylene functionalized by a rhodamine, obtained in Example 31.

### EXAMPLES

The experiments were carried out under an inert atmosphere. The reagents were purified beforehand and the solvents dried.

abbreviations used: BEM=butyl ethyl magnesium, commercial, supplied by Texas Alkyl, 20% by mass in heptane; THF=tetrahydrofuran; Et₂O=diethyl ether; HCp*=pentamethylcyclopentadiene; GC=gas chromatography; NMR=nuclear magnetic resonance; PE=polyethylene.

The commercial di-n-hexyl magnesium is supplied by Akzo-Nobel, 20% by mass in heptane.

MALDI-TOF mass spectrometer (Matrix assisted laser desorption/ionization) coupled with a Time of Flight Analyzer (Time Of Flight).

### Example 1

### Preparation of Polyethylene (PE) by Ethylene Polymerization Using Neodymium Versatate Nd(vers)₃

13.6 mg i.e. 23.7 μmol of neodymium versatate (represented by LnX3) and 7.0 mg i.e. 51 μmol of pentamethylcyclopentadiene (HC₅Me₅ represented by HCp*) are weighed in a glove box. The mixture is dissolved in 5 mL of anhydrous and degassed toluene and produces a green homogeneous solution. Also in a glove box, a solution of dialkyl magnesium compound in 15 mL of toluene is prepared, by weighing 111 mg i.e. 200 μmol of butyl ethyl magnesium (CH₃—CH₂−CH₂—CH₂−Mg—CH₂—CH₃ represented by BEM) in the form of a 20% by mass solution in heptane. The BEM solution is conveyed out of the glove box in a leak-tight syringe and immediately injected into a polymerization reactor supplied with ethylene (CH₂═CH₂) under a constant pressure of 1.5 bar and temperature-controlled at 90° C. The mechanical stirring is sufficient to rapidly reach saturation equilibrium of the gas in the solution. The solution of LnX₃ and HCp* is then injected into the reactor, which constitutes the start of the reaction. The progress of the reaction is monitored by measuring the flow rate of ethylene consumed over time (see FIG. 1). The highest catalytic activity of 800 kg/mol/h is observed towards 6-7 minutes, after an initial activity of 100 kg/mol/h that is stable for 4 minutes. After 15 minutes, the reaction appears to be completed as the ethylene consumption has stopped. The homogeneous solution is then poured under vigorous stirring at 20° C. into a solution constituted by 100 mL of degassed methanol and 1 mL of concentrated hydrochloric acid. The resultant flocculent precipitate is filtered, rinsed with pure methanol, then dried. 1.05 g of white powder is obtained, which ¹H and ¹³C nuclear magnetic resonance analyses, infra-red spectroscopy, steric exclusion chromatography and by differential scanning calorimetry have characterized as being linear polyethylene CH₃(—CH₂)ₓ—CH₃ with an average value of x of approximately 200 and a dispersity of 1.2. This corresponds to dialkyl magnesium compounds of Bu-(CH₂—CH₂)ₙ—Mg—(CH₂—CH₂)ₘ-Et type in which the number of ethylene molecules growing in the two carbonated chains has an average n and m value of 100.

### Example 2

### Preparation of PE by Ethylene Polymerization Using Neodymium Chloride NdCl₃

With a procedure similar to Example 1, 39.4 mg i.e. 0.1 mmol of neodymium chloride having 2 equivalents of tetrahydrofuran adduct (NdCl₃THF₂ represented by LnX′₃) and 6.2 mg i.e. 45 μmol of HCp* in 5 mL of anhydrous and degassed toluene is prepared by weighing in a glove box. After stirring vigorously for 5 minutes, the mixture remains heterogeneous in the form of a suspension of blue powder. Also in a glove box, a solution of BEM in 15 mL of toluene is prepared by weighing 110.5 mg of a 20% by mass solution of BEM in heptane. The solution of BEM is injected into a polymerization reactor supplied with ethylene under a constant pressure of 1.5 bar and temperature-controlled at 90° C., under mechanical stirring. The suspension containing LnX′₃ and HCp* in 5 mL of toluene is then injected into the reactor. The catalytic activity, calculated from the flow rate of ethylene consumed over time, is comprised between 1 and 3 kg/h/mol for the first 60 minutes, then the activity increases suddenly and passes through a maximum of 22 kg/h/mol towards 72 minutes before decreasing and tending towards zero activity after 90 minutes (see FIG. 1). The suspension is then treated by the usual procedure for removing the metal salts and compounds that are soluble in acidified methanol. 0.70 g of polyethylene having properties identical with the product of Example 1 is obtained.

Comparison of Examples 1 and 2 shows that, if the apparent activity of the system is compared with the quantity of catalyst actually present in the medium, then the formation of the catalyst is correct in the case of Example 1 due to the solubilization of the compounds of the mixture whereas it is adversely affected by the use of a neodymium salt that is not very soluble in toluene in the case of Example 2. However, the final polymer is identical in the two examples as it originates from long-chain dialkyl magnesium compounds the properties of which are linked to the initial quantity of BEM (identical in the two examples) and not to the quantity of neodymium present in the catalyst, which affects only the speed of the reaction.

See FIG. 1 for comparison of the activities linked to Examples 1 and 2.

### Example 3

### Preparation of PE by Ethylene Polymerization Using Neodymium Tert-Butylate Nd(OtBu)₃

With a procedure similar to Example 1, 36.9 mg, i.e. 0.1 mmol of neodymium tert-butylate (Nd((—OC(CH₃)₃)₃ represented by LnX″₃), 27 mg i.e. 0.2 mmol of HCp* and 2.8 g i.e. 5 mmol of BEM in 100 mL of toluene are used at 80° C., with an ethylene pressure of 1.1 bar. The catalytic activity, calculated from the flow rate of ethylene consumed over time, is constant at 30 kg/mol/h. After a period of 2 hours, the polymerization is stopped voluntarily in order to avoid the expected increase in activity, the precipitation of the products and their caking in the reactor. The viscous homogeneous solution is then treated by the usual procedure. 5.70 g of polyethylene with a number-average molar mass of 670 g/mol and dispersity of 1.3 is obtained. This corresponds to dialkyl magnesium compounds of Bu-(CH₂—CH₂)ₙ—Mg—(CH₂—CH₂)ₘ-Et type in which the number of ethylene molecules growing in the two carbonated chains has an average n and m value of 22.

### Example 4

### Preparation of PE by Ethylene Polymerization Using Neodymium Borohydride Nd(BH₄)₃

With a procedure similar to Example 1, 1.8 mg, i.e. 4.5 μmol of neodymium borohydride (Nd(BH₄)₃THF₃ represented by LnX′″₃), 3.1 mg i.e. 22.8 μmol of HCp* and 117 mg i.e. 208 μmol of BEM in 20 mL of toluene are used at 90° C., with an ethylene pressure of 2.0 bar. The catalytic activity, calculated from the flow rate of ethylene consumed over the course of time, is at first stable towards 500 kg/mol/h for a few minutes, then passes through a maximum at 4500 kg/mol/h towards 12 minutes before decreasing and tending towards zero activity after 30 minutes. After treatment by the usual procedure, 2.42 g of polyethylene is obtained, with a number-average molar mass of 5100 g/mol and dispersity of 1.8. This corresponds to dialkyl magnesium compounds of Bu-(CH₂—CH₂)ₘ—Mg—(CH₂—CH₂)ₘ-Et type in which the number of ethylene molecules growing in the two carbonated chains has an average n and m value of 180.

### Example 5

### Preparation of PE by Ethylene Polymerization Either Using the Pre-Catalyst Cp*₂NdCl₂Li(OEt₂)₂, or by the In Situ Process of the Present Invention, and Comparison of these Two Methods

With a procedure similar to Example 1, two series of experiments are carried out, each time using 4 μmol of rare earth. In the first series, called “in situ”, a mixture of LnX′″₃ and 2 equivalents of HCp* is used. In the second series, called “Cp*₂NdCl₂Li(OEt₂)₂”, the pre-catalyst bis(pentamethylcyclopentadienyl)neodymium chloride, lithium chloride adduct and two molecules of diethyl ether, Cp*₂NdCl₂Li(OEt₂)₂ are used. In each series, three experiments are carried out with different quantities of BEM: 40 μmol i.e. Mg/Nd=10, 200 μmol i.e. Mg/Nd=50 or 1 mmol i.e. Mg/Nd=250. The polymerization is carried out in 20 mL of toluene at 90° C. and at a constant ethylene pressure of 2.0 bar. During the reaction, a mass flow meter measures the quantity of ethylene consumed over the course of time. The data recorded for each experiment make it possible to characterize the activity of the catalytic system expressed in kg of ethylene consumed per mole of neodymium and per hour; the data are presented in the form of curves in FIG. 2. It is noted that the in situ catalytic system has the same characteristics as with the use of Cp*₂NdCl₂Li(OEt₂)₂: Stable activity can be observed if the quantity of magnesium compound is significant (the greater the Mg/Nd ratio, the lower this activity in intensity but the longer in duration). Significant activity is then observed, followed by deactivation of the catalytic system. In all the experiments, the reaction is stopped for chain lengths of the same order of magnitude and the masses of polyethylene are proportional to the quantities of alkyl borne by the magnesium.

See FIG. 2.

### Example 6

### Monitoring the Length of the Chains by GC

With a procedure similar to Example 1, 8.1 mg, i.e. 20 μmol of LnX′″₃ is used, with 7.5 mg i.e. 55 μmol of HCp* and 0.97 g i.e. 1.0 mmol of di-n-hexyl magnesium in the form of a 20% by mass solution in heptane. The reaction is carried out in 20 mL of toluene at 90° C., with an ethylene pressure of 1.1 bar. The catalytic activity is calculated from the value measured by the mass flow meter placed at the inlet of the ethylene at constant pressure. The activity, starting from zero at the moment of mixing in situ, increases in a few minutes and then stabilizes at 26 kg/mol/h. After reacting for 30 minutes, the mass of ethylene read on the mass flow meter totalizer is 550 mg. The reaction is stopped voluntarily before the end, with the aim of subjecting the hydrolysis product of the reaction to gas chromatography (GC) analysis. This analysis makes it possible to study the statistical distribution of the polyethylene chain lengths. The flame ionization detector (FID) signal is reproduced in FIG. 3. This shows a series of peaks which, by reference to standards, correspond to linear alkanes having an even number of carbon atoms from 12C to 44C. A quantitative assay by the addition of internal standard C13 makes it possible to determine the quantity of polymerized ethylene and the total number of chains. These numbers correspond respectively to the mass of ethylene measured with the flow meter and to the number of alkyls borne by the magnesium compound weighed at the start. The calculations also make it possible to determine the dispersity of 1.10. This value characterizes a very narrow distribution of the chain lengths, close to the Poisson statistical value. This information proves that the catalytic system is effective for well-controlled polymerization.

### Example 7

### Synthesis of PE by Ethylene Polymerization Using the Ligand Ethyltetramethylcyclopentadienyl

With a procedure similar to Example 6, but using the ligand precursor ethyltetramethylcyclopentadiene represented below instead of pentamethylcyclopentadiene, a consumption curve is obtained similar to that observed for Example 6. The stable activity is recorded at 28 kg/mol/h and the dispersity measured by GC is 1.12. The ligand studied therefore allows the in situ preparation of a catalytic system very similar to that obtained with Cp*.

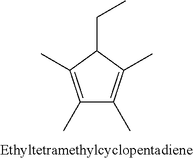

### Example 8

### Synthesis of PE by Ethylene Polymerization Using the Ligand Propyltetramethylcyclopentadienyl

With a procedure similar to Example 6, but using the ligand precursor tetramethylpropylcyclopentadiene represented below instead of pentamethylcyclopentadiene, a consumption curve is obtained similar to that observed for Example 6. The stable activity is recorded at 26 kg/mol/h and the dispersity measured by GC is 1.12. The ligand studied therefore allows the in situ preparation of a catalytic system very similar to that obtained with Cp*.

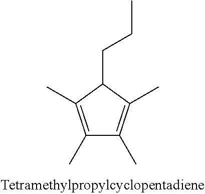

### Example 9

### Synthesis of PE by Ethylene Polymerization Using the Ligand Tetramethylcyclopentadienyl

With a procedure similar to Example 6, but using the ligand precursor tetramethylcyclopentadiene represented below instead of pentamethylcyclopentadiene, the activity is below the detection threshold. Another test carried out under the same operating conditions but with ten times less magnesium compound, i.e. with 0.1 mmol of di-n-hexyl magnesium, made it possible to observe a maximum activity of 17 kg/mol/h. The polymer obtained after polymerization of 55 mg of ethylene, according to GC analysis, is similar to that of Example 6. However the dispersity of 1.23 and the presence of light alkanes (hexane, octane) reflects the difficulty of the catalyst in rapidly carrying out the mechanism of the transfer of alkyls to the growth site. The ligand studied therefore allows the in situ preparation of a catalytic system less active in terms of growth and chain transfer, than that obtained with Cp*.

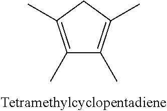

### Example 10

### Synthesis of PE by Ethylene Polymerization Using the Ligand 1,3,5-triphenylcyclopentadienyl

With a procedure similar to Example 6, but using the ligand precursor 1,3,5-triphenylcyclopenta-1,3-diene represented below instead of pentamethylcyclopentadiene, a consumption curve is obtained very different from that observed for Example 6: the activity is high after a few minutes (185 kg/mol/h) and then decreases slowly. According to GC analysis, the polymer obtained has a dispersity of 1.15 and significant quantities, 9 mol. %, of vinyl terminations. These chains result from an irreversible transfer mechanism. The ligand studied therefore allows the in situ preparation of a catalytic system different from that obtained with Cp*, less selective for the production of long-chain dialkyl magnesium compounds.

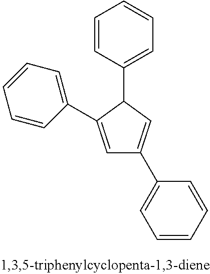 [SMILES: C1=C(c2ccccc2)C=C(c2ccccc2)C1c1ccccc1]

### Example 11

### Synthesis of PE by Ethylene Polymerization Using the Ligand 1,2,3-triphenylcyclopentadienyl

With a procedure similar to Example 6, but using the ligand precursor 1,2,3-triphenylcyclopentadiene represented below instead of pentamethylcyclopentadiene, a fairly low consumption curve is obtained (maximum 10 kg/mol/h). According to GC analysis, the polymer obtained has a very wide dispersity of 1.34 and significant quantities, 20 mol. %, of vinyl terminations. The ligand studied therefore allows the in situ preparation of a catalytic system different from that obtained with Cp*, not very compatible with the production of long-chain dialkyl magnesium compounds.

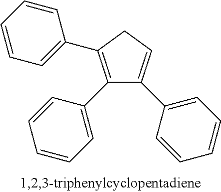 [SMILES: C1=C(c2ccccc2)C(c2ccccc2)=C(c2ccccc2)C1]

### Example 12

### Synthesis of PE by Ethylene Polymerization Using the Ligand 1,2,3,4-tetramethyl-5-trimethylsilylcyclopentadienyl

With a procedure similar to Example 6, but using the ligand precursor trimethyl(2,3,4,5-tetramethyl-cyclopenta-2,4-dien-1-yl)silane represented below, instead of pentamethylcyclopentadiene, a decreasing consumption curve is obtained starting from a fairly high value (maximum 45 kg/mol/h). According to GC analysis, the polymer obtained has a dispersity of 1.10. The ligand studied therefore allows the in situ preparation of a catalytic system different from that obtained with Cp*.

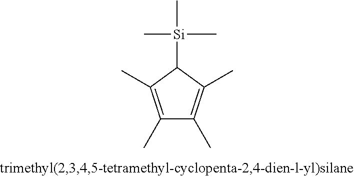

### Example 13

### Synthesis of PE by Ethylene Polymerization Using the Ligand 1,2,3,4-tetraphenylcyclopentadienyl

With a procedure similar to Example 6, but using the ligand precursor 1,2,3,4-tetraphenylcyclopentadiene represented below, instead of pentamethylcyclopentadiene, a very low consumption curve is obtained (maximum 4 kg/mol/h). For a quantity of magnesium compound ten times lower, the activity increases to 10 kg/mol/h. The ligand studied therefore allows the in situ preparation of a catalytic system different from that obtained with Cp*.

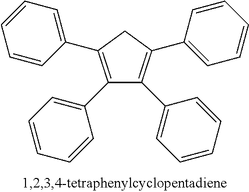 [SMILES: c1ccc(C2=C(c3ccccc3)C(c3ccccc3)=C(c3ccccc3)C2)cc1]

### Example 14

### Synthesis of PE by Ethylene Polymerization Using the Ligand 1,2,3,4-tetraisopropylcyclopentadienyl

With a procedure similar to Example 6, but using the ligand precursor 1,2,3,4-tetraisopropylcyclopentadiene represented below instead of pentamethylcyclopentadiene, the activity is below the detection threshold. The ligand studied does not therefore allow the in situ preparation of a catalytic system for polyethylene chain growth on the magnesium compounds under the conditions studied.

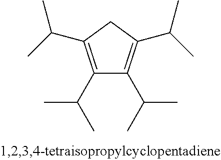 [SMILES: CC(C)C1=C(C(C)C)C(C(C)C)=C(C(C)C)C1]

### Example 15

### Synthesis of PE by Ethylene Polymerization Using the Ligand Cyclopentadienyl

With a procedure similar to Example 6, but using the ligand precursor cyclopenta-1,3-diene represented below, instead of pentamethylcyclopentadiene, the activity is below the detection threshold. The ligand studied does not therefore allow the in situ preparation of a catalytic system for polyethylene chain growth on the magnesium compounds under the conditions studied.

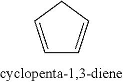

### Example 16

### Synthesis of PE by Ethylene Polymerization Using the Ligand Fluorenyl

With a procedure similar to Example 6, but using the ligand precursor fluorene represented below, instead of pentamethylcyclopentadiene, the activity is below the detection threshold. The ligand studied does not therefore allow the in situ preparation of a catalytic system for polyethylene chain growth on the magnesium compounds under the conditions studied.

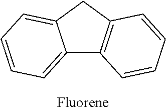 [SMILES: c1ccc2c(c1)Cc1ccccc1-2]

### Example 17

### Synthesis of PE by Ethylene Polymerization Using the Bridged Ligand Fluorenyl and Cyclopentadienyl

With a procedure similar to Example 6, but using 1 equivalent (20 μmol) of ligand precursor 2-fluorenyl-2-cyclopentadienylpropane represented below, instead of pentamethylcyclopentadiene, the activity is below the detection threshold. The ligand studied does not therefore allow the in situ preparation of a catalytic system for polyethylene chain growth on the magnesium compounds under the conditions studied.

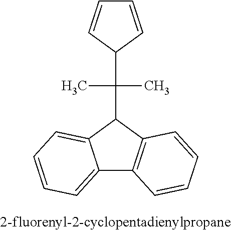 [SMILES: CC(C)(C1C=CC=C1)C1c2ccccc2-c2ccccc21]

### Example 18

### Synthesis of PE by Ethylene Polymerization Using the Bridged Ligand CpSiMe₂NPh

With a procedure similar to Example 6, but using 1 equivalent (20 μmol) of ligand precursor (2,4-cyclopentadienyl-dimethyl-silanyl)-phenylamine represented below, instead of pentamethylcyclopentadiene, the activity is below the detection threshold. The ligand studied does not therefore allow the in situ preparation of a catalytic system for polyethylene chain growth on the magnesium compounds under the conditions studied.

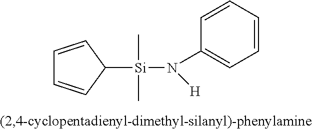

### Example 19

### Synthesis of PE by Ethylene Polymerization Using the Bridged Ligand Carboranyl and Cyclopentadienyl

With a procedure similar to Example 6, but using 1 equivalent (20 μmol) of ligand precursor 2-(2,4-cyclopentadienyl)-2-carboranyl-propane represented below, instead of pentamethylcyclopentadiene, the activity is below the detection threshold. The ligand studied does not therefore allow the in situ preparation of a catalytic system for polyethylene chain growth on the magnesium compounds under the conditions studied.

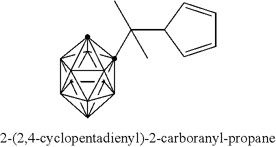

### Example 20

### Synthesis of PE by Ethylene Polymerization Using the Ligand ansaCp

With a procedure similar to Example 6, but using 1 equivalent (20 μmol) of ligand precursor 2,3-dimethyl-2,3-di(2,4-cyclopentadienyl)-butane represented below, instead of pentamethylcyclopentadiene, the activity is below the detection threshold. The ligand studied does not therefore allow the in situ preparation of a catalytic system for polyethylene chain growth on the magnesium compounds under the conditions studied.

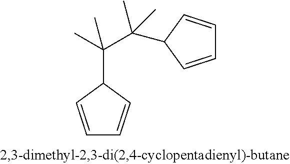 [SMILES: CC(C)(C1C=CC=C1)C(C)(C)C1C=CC=C1]

### Example 21

### Synthesis of PE by Ethylene Polymerization Using the Ligand NacNac(Mesityl)

With a procedure similar to Example 6, but using 1 equivalent (20 μmol) of ligand precursor N,N-di(2,4,6-trimethylphenyl)-2,4-pentanediimine represented below, instead of pentamethylcyclopentadiene, the activity is below the detection threshold. The ligand studied does not therefore allow the in situ preparation of a catalytic system for polyethylene chain growth on the magnesium compounds under the conditions studied.

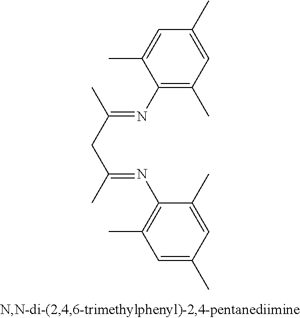 [SMILES: C/C(C/C(C)=N/c1c(C)cc(C)cc1C)=N\c1c(C)cc(C)cc1C]

### Example 22

### Preparation of Primary Alcohol-Functionalized PE, PE-OH

With a procedure similar to Example 6, polymerization is carried out over 30 minutes, the mass of ethylene consumed being 550 mg. The reactor is then purged by bubbling pure oxygen through the solution for 5 minutes. The reaction medium is then treated with the usual procedure. A sample of the polymer obtained is subjected to ¹³C nuclear magnetic resonance (NMR) analysis, in solution in CDCl₃. The spectrum is represented in FIG. 4. It is noted that the product is constituted by polyethylene chains one end of which comprises a primary alcohol function.

### Example 23

### Preparation of Carboxylic Acid-Functionalized PE, PE-COOH

With a procedure similar to Example 6, polymerization is carried out over 30 minutes, the mass of ethylene consumed being 550 mg. The reactor is then purged by bubbling pure carbon dioxide (CO₂) through the solution for 5 minutes. The reaction medium is then treated with the usual procedure. A sample of the polymer obtained is subjected to ¹³C NMR analysis, in solution in CDCl₃. It is noted that the product is constituted by polyethylene chains one end of which comprises a carboxylic acid function.

### Example 24

### Preparation of Alpha Olefin-Functionalized PE

With a procedure similar to Example 6, but carried out in 20 mL of isododecane instead of toluene. The ethylene inlet is closed after reaction for 35 minutes, the mass of ethylene read on the totalizer of the mass flow meter being 550 mg. The reactor is then heated rapidly to 180° C. and maintained at this temperature for 30 minutes. The reaction medium becomes heterogeneous with the formation of a white precipitate. It is then treated with the usual procedure (N.B.: the hydrolysis is violent, with release of hydrogen). A sample of the polymer obtained is subjected to ¹³C NMR analysis, in solution in CDCl₃. It is noted that the product is constituted by polyethylene chains one end of which comprises a terminal alkene function.

### Example 25

### Preparation of Thiol-Functionalized PE

With a procedure similar to Example 6, polymerization is carried out over 30 minutes, the mass of ethylene consumed being 550 mg. The reactor is then purged by bubbling argon through the solution for 5 minutes. A solution of 593 mg i.e. 2.0 mmol of tetraethylthiurame sulphide (disulphiram) in 5 mL of toluene is injected into the reactor and the mixture is maintained under stirring at 90° C. for 1 h. The reaction medium is then treated by precipitation from 100 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which comprises an N,N-diethylcarbamate function. The carbamate-functionalized polymer is dissolved in 20 mL of toluene at 90° C. and 759 mg i.e. 20 mmol of lithium aluminium hydride (LiAlH₄) in 10 mL of tetrahydrofuran (THF) is added. The mixture is maintained under reflux for 1 h then filtered while hot in order to separate the precipitates. The filtrate is then treated by precipitation from 100 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which comprises a thiol function.

### Example 26

### Preparation of PE Functionalized with Iodine Derivative

With a procedure similar to Example 6, polymerization is carried out over 30 minutes, the mass of ethylene consumed being 550 mg. The reactor is then purged by bubbling argon through the solution during its cooling down to ambient temperature. A solution of 2.0 grams i.e. 8.0 mmol of diiodine (I₂) in 5 mL of toluene is injected into the reactor and the mixture is maintained under stirring at 20° C. for 1 hour. The reaction medium is then treated by precipitation from 100 mL of methanol, washed with methanol until discolouration is complete, then dried under vacuum at ambient temperature. A sample of the polymer obtained is subjected to ¹³C NMR analysis, in solution in CDCl₃. It is noted that the product is constituted by polyethylene chains one end of which comprises an iodo function.

### Example 27

### Preparation of Azide-Functionalized PE

The product prepared according to Example 26 is dissolved in 20 mL of toluene under reflux, then 156 mg i.e. 2.4 mmol of sodium azide (NaN₃) in 20 mL of dimethylformamide (DMF) is added and the mixture is maintained under reflux under stirring for 4 hours. The reaction medium is then treated by precipitation from 200 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which comprises an azido function.

### Example 28

### Preparation of Amine-Functionalized PE

The product prepared according to Example 27 is dissolved in 20 mL of toluene under reflux, then 759 mg i.e. 20 mmol of lithium aluminium hydride (LiAlH₄) in 10 mL of tetrahydrofuran (THF) is added. The mixture is maintained under reflux for 1 hour. The reaction medium is then treated by precipitation from 200 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which comprises an amino function.

### Example 29

### Preparation of PE Functionalized by a Porphyrin

1.6 g i.e. 2.5 mmol of ethynylporphyrin represented by the following formula is dissolved in 20 mL of toluene at 110° C.:

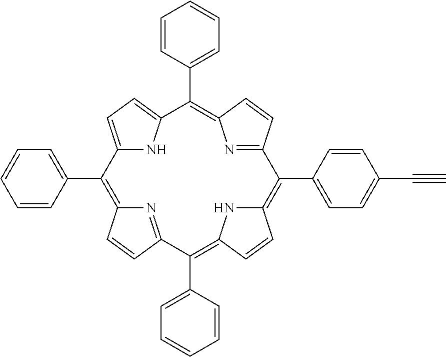 [SMILES: C#Cc1ccc(-c2c3nc(c(-c4ccccc4)c4ccc([nH]4)c(-c4ccccc4)c4nc(c(-c5ccccc5)c5ccc2[nH]5)C=C4)C=C3)cc1]

This solution is added to a mixture of 2.87 g i.e. 20 mmol of copper bromide(CuBr) and 3.47 g i.e. 20 mmol of 2,5,8-trimethyl-2,5,8-triazanonane (PMDETA or pentamethyldiethylenetriamine) in 20 mL of toluene at 110° C. The mixture is then poured into a solution, in 20 mL of toluene under reflux, of azido-functionalized polyethylene, prepared according to Example 27. After reaction for 30 minutes, the reaction medium is treated by precipitation from 200 mL of methanol, washed with methanol then dried under vacuum at ambient temperature. A sample of the polymer obtained is subjected to ¹³C NMR analysis, in solution in CDCl₃ and mass spectrometry analysis using the matrix-assisted laser desorption/ionization (MALDI) technique and a time of flight (TOF) detector. It is noted that the product is constituted by polyethylene chains one end of which is linked by a triazole ring to a porphyrin with a copper nucleus. It is purple in colour.

### Example 30

### Preparation of PE Functionalized by a Fluorescent Rhodamine

With a procedure similar to Example 6, polymerization is carried out over 30 minutes, the mass of ethylene consumed being 550 mg. Then a solution of 885 mg i.e. 2.0 mmol of rhodamine B base (solvent red 49) of the following formula in 20 mL of toluene is added:

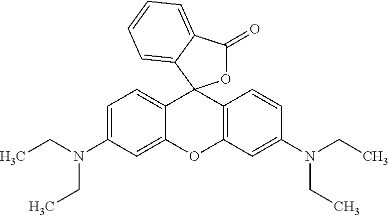 [SMILES: CCN(CC)c1ccc2c(c1)Oc1cc(N(CC)CC)ccc1C21OC(=O)c2ccccc21]

After reaction for 30 minutes, the reaction medium is treated by precipitation from a mixture of 100 mL of methanol and 100 mL of concentrated hydrochloric acid 32 mol/L, washed with pure methanol then dried under vacuum at ambient temperature. A sample of the polymer obtained is subjected to ¹³C NMR analysis, in solution in CDCl₃ and mass spectrometry analysis using the matrix-assisted laser desorption/ionization (MALDI) technique and a time of flight (TOF) detector. It is noted that the product is constituted by polyethylene chains one end of which is linked to a rhodamine-type group.

### Example 31

### Preparation of PE Functionalized by a Fluorescent Rhodamine

Using the procedure of Example 6 but using 0.55 g i.e. 1.0 mmol of BEM instead of di-n-hexyl magnesium, polymerization is carried out over 30 minutes, the mass of ethylene consumed being 550 mg. Then a solution of 885 mg i.e. 2.0 mmol of rhodamine B base (solvent red 49) of the following formula in 5 mL of toluene is added:

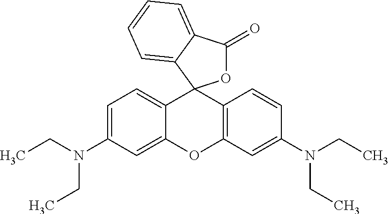 [SMILES: CCN(CC)c1ccc2c(c1)Oc1cc(N(CC)CC)ccc1C21OC(=O)c2ccccc21]

After reaction for 30 minutes, the reaction medium was treated by precipitation from a mixture of 25 mL of methanol and 25 mL of concentrated hydrochloric acid, 32 mol/L, filtered, washed with 10 mL of pure methanol (limited quantity as the product is partially soluble in pure methanol) then dried under vacuum at ambient temperature. The product is fluorescent red and its mass is 0.9 g. A sample of the product was subjected to mass spectrometry analysis using the matrix-assisted laser desorption/ionization (MALDI) technique and a time of flight (TOF) detector. The detector signal has been reproduced in FIG. 5. According to this, it can be seen that the product is constituted by chains comprising 9 to 24 ethylene units (narrow distribution centred on 15-16 units) and linked to a rhodamine-type group, of the following formula:

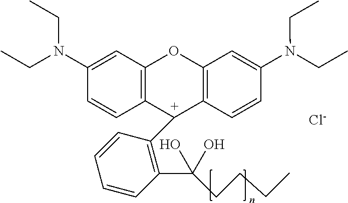

n being comprised between 7 and 23, of average value 14.

### Example 32

### Preparation of PE Functionalized with Methacrylate-Type Macroinitiator

The azido-functionalized polyethylene, prepared according to Example 27, is dissolved in 10 mL of dimethylformamide (DMF) at 130° C. 660 mg i.e. 6.0 mmol of propargyl acrylate, then 120 mg i.e. 0.6 mmol of sodium ascorbate, then 48 mg i.e. 0.3 mmol of copper sulphate (CuSO₄) are added successively. The solution passes from yellow to dark brown and is maintained at 130° C. for 10 minutes. The reaction medium is then treated by precipitation from 200 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which is bound by a triazole ring to an acrylate group.

### Example 33

### Preparation of n-Butyl Polyacrylate Having Polyethylene Blocks Arranged Laterally with Respect to the Main Chain

The polyethylene functionalized with acrylate-type macroinitiator, prepared according to Example 32, is dissolved in 20 mL of toluene at 85° C. 3.2 g i.e. 25 mmol of n-butyl acrylate (nBuA), then 41 mg i.e. 0.25 mmol of 2,2′-azobis(2-methylpropionitrile) (AIBN) are added successively. After 1 hour at 85° C., the reaction medium is concentrated by evaporation of the solvent then dried under vacuum for 16 h in order to produce a transparent, pasty and sticky residue. A sample of the polymer obtained is subjected to ¹³C NMR analysis, in solution in CDCl₃. It is noted that the product is a random copolymer of n-butyl acrylate and alkyl acrylate linked by a triazole ring to a polyethylene chain. The architecture of the molecular structure consists of main chains of polyacrylates, each lateral ester function of which bears either a butyl, or a polyethylene secondary block chain.

### Example 34

### Preparation of Polyethylene Functionalized with RAFT-Type Macroinitiator

The reversible addition and fragmentation transfer (RAFT) agent, 4-cyano-4-(thiobenzoylthio)pentanoic acid, 560 mg i.e. 2.0 mmol, is firstly functionalized by N-hydroxysuccinimide (NHS), 276 mg i.e. 2.4 mmol, in 10 mL of chloroform at ambient temperature, for 2 hours, in the presence of 500 mg i.e. 2.4 mmol of dicyclohexylcarbodiimide (DCC). After evaporation of the solvent, the part that is soluble in acetone is extracted then dried under vacuum. The RAFT agent functionalized by NHS is then added to the amino-functionalized polyethylene prepared according to Example 28, dissolved in 20 mL of toluene at 90° C. After reaction for 1 hour, the solution is treated by precipitation from 100 mL of methanol, washed with methanol then dried under vacuum at ambient temperature. A sample of the polymer obtained is subjected to ¹³C NMR analysis, in solution in CDCl₃. It is noted that the product is constituted by polyethylene chains one end of which is bound by an amide function to a RAFT agent.

### Example 35

### Preparation of Polyethylene-n-Butyl Polyacrylate Block Copolymer

The polyethylene functionalized with RAFT-type macroinitiator, prepared according to Example 34, is dissolved in 20 mL of toluene at 85° C. 3.2 g i.e. 25 mmol of n-butyl acrylate (nBuA), then 41 mg i.e. 0.25 mmol of 2,2′-azobis(2-methylpropionitrile) (AIBN) are added successively. After 6 hours at 85° C., the reaction medium is treated with the usual procedure. A sample of the polymer obtained is subjected to ¹³C NMR analysis, in solution in CDCl₃. It is noted that the product is constituted by polyethylene chains one end of which is bound by an amide function to an n-butyl polyacrylate chain.

### Example 36

### Preparation of Polyethylene-Methyl Polymethacrylate Block Copolymer

With a procedure similar to Example 6, polymerization is carried out over 30 minutes, the mass of ethylene consumed being 550 mg. Then 20 mL of THF is added and the reactor is cooled down to −78° C. 2 g of methyl methacrylate is added to the heterogeneous suspension and left to react for 2 hours. The reaction medium is then treated with the usual procedure. A sample of the polymer obtained is subjected to ¹³C NMR analysis, in solution in CDCl₃. It is noted that the product is constituted by polyethylene chains linked to methyl polymethacrylate chains.

### Example 37

### Preparation of Ethylene-Styrene Random Copolymer

With a procedure similar to Example 1, a solution of 1.6 mg i.e. 4 μmol of LnX′″₃ in 1 mL of toluene is prepared, with 0.8 mg i.e. 6 μmol of HCp*. The proportions of ligand precursors were provided in order to have the coexistence of 2 μmol of metallocene and 2 μmol of hemimetallocene. Moreover, 110.5 mg i.e. 200 μmol of BEM is prepared in the form of a 20% by mass solution in heptane and 35 mg i.e. 200 μmol of crown ether 1,4,7,10-tetraoxacyclododecane (12-crown-4) in 1 mL of toluene. The solutions of magnesium compound then of rare earth are injected in that order into the polymerization reactor containing 20 mL of styrene at 90° C., under an ethylene pressure of 1.1 bar. After reaction for 1 hour, the reaction medium is treated with the usual procedure. A sample of the polymer obtained is subjected to ¹³C NMR analysis, in solution in CDCl₃. Whilst the metallocene catalyst is known to form polyethylene chains only, and the hemimetallocene catalyst is known to preferentially form polystyrene chains, the product obtained in this example comprises chains randomly combining ethylene and styrene. The proportion of styrene is less than 5 mol. % and the phenyl substituents on the polyethylene chain are isolated from one another.

### Example 38

### Preparation of Ethylene-Butadiene Random Copolymer

With a procedure similar to Example 1, a solution of 1.6 mg i.e. 4 μmol of LnX′″₃ in 1 mL of toluene is prepared, with 0.6 mg i.e. 4 μmol of HCp* as well as 0.5 mg i.e. 2 μmol of 2-fluorenyl-2-cyclopentadienylpropane (FIG. 14). The two ligand precursors are intended to form two catalysts in coexistence, a decamethylmetallocene and a bridged metallocene respectively. Moreover, 110.5 mg i.e. 200 μmol of BEM is prepared in the form of a 20% by mass solution in heptane and 35 mg i.e. 200 μmol of crown ether 1,4,7,10-tetraoxacyclododecane (12-crown-4) in 1 mL of toluene. The solutions of magnesium compound then of rare earth are injected in that order into the polymerization reactor containing 20 mL of toluene at 90° C., under a pressure of 1.1 bar of a gaseous mixture of 5% buta-1,3-diene (BD) in ethylene. After reaction for 1 hour, the reaction medium is treated with the usual procedure. A sample of the polymer obtained is subjected to ¹³C NMR analysis, in solution in CDCl₃. Whilst the decamethylmetallocene catalyst is known to form polyethylene chains only and the bridged metallocene catalyst is known to preferentially form alternating ethylene and butadiene copolymer chains, the product obtained in this example comprises chains randomly combining ethylene and butadiene. The proportion of butadiene is less than 5% and the trans-type double bonds separated from one another by more than 6 carbon atoms on the polyethylene chains.

### Example 39

### Preparation of Polyethylene-Poly-ε-Caprolactone Block Copolymer

With a procedure similar to Example 1, a solution of 0.6 mg i.e. 1 μmol of neodymium versatate LnX₃ is prepared in 20 mL of toluene, with 0.3 mg i.e. 2 μmol of HCp*. Moreover, 552 mg i.e. 1.0 mmol of BEM is prepared in the form of a 20% by mass solution in heptane and 176 mg i.e. 1 mmol of crown ether 1,4,7,10-tetraoxacyclododecane (12-crown-4) in 20 mL of toluene. The solutions of magnesium compound then of rare earth are injected in that order into a 600 mL polymerization reactor containing 400 mL of toluene at 90° C., under an ethylene pressure of 5.0 bar. After reaction for 1 hour, 100 g of ε-caprolactone (eCL) is injected into the reactor. The reaction medium becomes viscous in 10 minutes. It is then treated with the usual procedure. A sample of the polymer obtained is subjected to ¹³C NMR analysis, in solution in CDCl₃. It is noted that the product contains polyethylene chains linked to poly-ε-caprolactone chains.

### Example 40

### Preparation of Polyethylene-Trans-Polyisoprene Block Copolymer

With a procedure similar to Example 1, 1.6 mg i.e. 4 μmol of LnX′″ is used, with 1.1 mg i.e. 8 μmol of HCp* and 110.5 mg i.e. 200 μmol of BEM in the form of a 20% by mass solution in heptane. The polymerization reaction is carried out in 20 mL of toluene at 90° C., with an ethylene pressure of 1.1 bar, over a period of 60 minutes. The ethylene consumption read on the totalizer of the mass flow meter is 1.01 g. During this time, in a glove box, a solution of 162 mg, i.e. 400 μmol of LnX₃′″ in 5 mL of toluene is prepared under vigorous stirring for 10 minutes. Then 10 g, i.e. 147 mmol of isoprene is added to it. This blue solution is injected into the polymerization reactor at the 60th minute of ethylene consumption. The reaction medium immediately becomes bright green and the pressure rises to 1.8 bar. Then the pressure drops progressively while the viscosity of the solution increases over the next 10 minutes. The medium is then treated with the usual procedure. 5.09 g of polyethylene-trans-polyisoprene block copolymer is obtained. ¹³C NMR analysis in C₂D₂Cl₄ at a temperature of 304K indicates that the chains have an average of 90 ethylene units and 150 isoprene units, the selectivity of the isoprene insertions is 82% of trans type, 10% of cis type and 8% of 3,4 type.

### Example 41

### Preparation of Polyethylene-Polylactic Acid PE-PLA Block Copolymer

Using the procedure of Example 1, a solution of 10 mg i.e. 15 μmol of neodymium versatate LnX₃ and 4.1 mg i.e. 30 μmol of pentamethylcyclopentadiene HCp* in 2 mL of toluene is prepared. Moreover, 55 mg i.e. 100 μmol of butyl ethyl magnesium BEM is prepared, in the form of a 20% by mass solution in heptane, in 20 mL of toluene. The solutions of magnesium compound then of rare earth were injected in that order into a 100 mL polymerization reactor, at 90° C., under an ethylene pressure of 1.2 bar. The progress of the reaction was monitored by measuring the flow rate of ethylene consumed over the course of time. After reaction for 5 min, the flow rate having passed through a maximum and beginning to decrease, the quantity of ethylene was measured by integration of the flow rate and represents a mass of 400 mg. At this point in time, a solution of 1.44 g i.e. 10 mmol of L-lactide in 35 mL of toluene was injected into the polymerization reactor. After reaction for 1 h, the reaction medium was treated with the procedure of Example 1. 714 mg of hard and friable polymer was obtained. A sample was subjected to ¹³C NMR analysis, in solution in C₂D₂Cl₄ at 120° C. It was noted that the product contained polyethylene chains linked to polylactic acid chains.

1. Process for the preparation by ethylene polymerization of at least one dialkyl magnesium compound of formula R—(CH₂—CH₂)ₙ—Mg—(CH₂—CH₂)ₘ—R′ in which R and R′, identical or different, represent cyclic or non-cyclic, substituted or unsubstituted, linear or branched aryl, benzyl, allyl or alkyl groups, comprising from 1 to 20 carbon atoms and in which the integers n and m, identical or different, represent average —CH₂—CH₂— chain formation numbers greater than 1, in particular from 20 to 200,
said process comprising a single stage of mixing the following components:
at least one ligand or one ligand precursor,
at least one rare earth salt of formula MX₃ in which M represents the rare earth element in the cationic form chosen from scandium, yttrium or the lanthanides and X the anion which is associated therewith,
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
and ethylene,
in a medium allowing contact between the components of the above mixture,
said contact allowing the formation of a catalyst between M, the magnesium and the ligand or the ligand precursor,
said medium being compatible with ethylene polymerization, which leads to a polymerization product or mixture of products of formula R—(CH₂—CH₂)ₙ—Mg—(CH₂—CH₂)ₘ—R′ in which R, R′, n and m have the meanings given above.

2. Process according to claim 1, in which the Mg/M molar ratio is greater than 1 and in particular varies from 5 to 100,000, and in particular from 10 to 250, and in particular from 50 to 100, and in particular is equal to 50.

3. Process according to claim 1, in which the components of the mixture are the following:
at least one ligand or one ligand precursor,
at least one rare earth salt of formula MX₃ in which M represents the rare earth element in the cationic form chosen from scandium, yttrium or the lanthanides and X the anion associated therewith,
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
at least one Lewis base chosen from the linear or cyclic ethers, crown ethers, and in particular diethyl ether or tetrahydrofuran, provided that the quantity of said base does not exceed 10 equivalents with respect to the quantity of magnesium compound,
and ethylene.

4. Process according to claim 1, in which the medium allowing contact between the components of the mixture contains a solvent or a mixture of solvents in which the components of the mixture are soluble or partially soluble,
said medium and the solvent or mixture of solvents constituting the reaction medium.

5. Process according to claim 1, in which the reaction medium formed by:
at least one ligand or one ligand precursor,
at least one rare earth salt of formula MX₃ in which M represents the rare earth element in the cationic form chosen from scandium, yttrium or a lanthanide and X the anion associated therewith, X being different from Cl⁻, Br⁻, I⁻,
at least one dialkyl magnesium compound of formula R—Mg—R′ in which R and R′, identical or different, represent cyclic or non-cyclic, substituted or unsubstituted, linear or branched aryl, benzyl, allyl or alkyl groups, comprising from 1 to 20 carbon atoms,
optionally at least one Lewis base chosen from the linear or cyclic ethers or crown ethers, and in particular diethyl ether or tetrahydrofuran, provided that the quantity of said base does not exceed 10 equivalents with respect to the quantity of magnesium compound,
ethylene,
solvent or a mixture of solvents,
catalyst,
polymerization products,
is homogeneous.

6. Process according to claim 1, in which when a Lewis base is present, it originates from the ligand and/or from the rare earth salt, and/or from the solvent or from the mixture of solvents.

7. Process according to claim 1, in which the solvent or the constituents of the mixture of solvents are chosen from
the linear, branched or cyclic alkanes comprising from 5 to 20 carbon atoms,
the aromatic compounds comprising from 5 to 20 carbon atoms, optionally substituted by linear, branched or cyclic alkyl groups comprising from 1 to 20 carbon atoms, these alkyl groups being optionally linked to another position on the same aromatic ring in order to form a side ring,
the halogenated compounds, in particular chlorobenzene, chloroform, dichloromethane, tetrachloromethane,
the free electron-pair donor compounds, in particular the linear or cyclic ethers or crown ethers, and in particular diethyl ether or tetrahydrofuran, provided that the quantity of these compounds does not exceed 10 equivalents with respect to the quantity of magnesium compound.

8. Process according to claim 1, in which the ligand precursor has the formula ^{Ra}CpH in which ^{Ra}CpH represents an optionally substituted cyclopentadiene derivative of formula 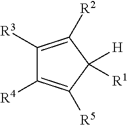
in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, moreover linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene.

9. Process according to claim 1, in which the catalyst obtained in situ between the rare earth salt MX₃, the dialkyl magnesium compound of formula R—Mg—R′ and the ligand precursor ^{Ra}CpH, is used without being isolated from the reaction medium, said catalyst being a metallocene or a hemimetallocene of the metal M combined with the magnesium by the R and R′ groups.

10. Process according to claim 1, in which the rare earth salt has the formula MX₃ in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatates, borohydride, or tert-butylate.

11. Process according to claim 1, in which the temperature of the reaction medium varies from −78° C. to 200° C., and is in particular from 20° C. to 110° C., and in particular is equal to 90° C.

12. Process according to claim 1, in which the reaction medium is saturated with ethylene over the duration of the reaction by feeding with ethylene, the ethylene pressure varying from 0.1 bar to 1,000 bar, in particular varying from 1 to 50 bar, and is in particular equal to 1.1 bar.

13. Process according to claim 1, in which the reaction medium is heterogeneous due to the immobilization of at least one of the components of the mixture, ligand or ligand precursor, rare earth salt, dialkyl magnesium compound, on a solid support, said chosen support being a support based on silica, alumina, metal oxide, in particular Nd₂O₂ or CeO₂, metal salt, in particular MgCl₂, synthetic polymer, in particular polystyrene sulphonate, or natural polymer, in particular a polysaccharide, clay, zeolite, MOF (Metal Organic Frameworks), ceramics, nanotube of carbon, graphene.

14. Process according to claim 1, in which the reaction medium is heterogeneous due to the immobilization of the ligand or of the ligand precursor, on a solid support, said chosen support being a support based on silica, alumina, metal oxide, in particular Nd₂O₃ or CeO₂, metal salt, in particular MgCl₂, synthetic polymer, in particular polystyrene sulphonate, or natural polymer, in particular a polysaccharide, clay, zeolite, MOF (Metal Organic Frameworks), ceramics, nanotube of carbon, graphene.

15. Process according to claim 1, comprising an additional stage of adding at least one polar monomer to the polymerization products of formula R—(CH₂—CH₂)ₙ—Mg—(CH₂—CH₂)ₘ—R′, R and R′ having the meanings defined in claim 1, in order to obtain a copolymer.

16. Process according to claim 1, comprising an additional stage of addition of an olefin, in particular chosen from
the conjugated dienes, in particular butadiene, isoprene, myrcene or ocimene,
the alpha-omega-dienes, in particular 1,5-hexadiene,
the aromatic vinyl compounds, in particular styrene, paramethylstyrene, alphamethylstyrene,
the alpha-olefins, in particular propene, butene, hexene, and octene,
said additional stage being carried out on the polymerization products of formula R—(CH₂—CH₂)ₙ—Mg—(CH₂—CH₂)ₘ—R′, R, R′, in order to obtain a copolymer.

17. Process according to claim 1, in which the polar monomer is chosen from the alkyl (meth)acrylates, (meth)acrylonitrile, the vinylpyridines, the lactones, the lactides, the lactames, the cyclic carbonates, the silsesquioxanes, the isocyanates, the epoxies, in particular methyl methacrylate, epsilon-caprolactone, L-lactide, ethylene carbonate.

18. Process according to claim 1, in which the mixture of components comprises:
a first ligand or ligand precursor of formula ^{Ra}CpH, in which ^{Ra}CpH represents an optionally substituted cyclopentadiene derivative, of formula 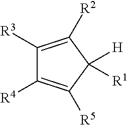
in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, in addition linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene,
a second ligand or ligand precursor of formula ^{Rb}CpH the meaning of which is the same as that given above for ^{Ra}CpH, provided that ^{Ra}CpH and ^{Rb}CpH are different,
at least one rare earth salt of formula MX₃, in which M represents a rare earth element chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium ₆₁Pm, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu,
and in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatate, borohydride, or tert-butylate ion.

19. Process according to claim 1, in which the mixture of components comprises
a first ligand or ligand precursor of formula ^{Ra}CpH, in which ^{Ra}CpH represents an optionally substituted cyclopentadiene derivative, of formula 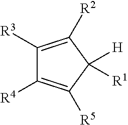
in which the substituents R¹ to R⁵ are identical or different and independently chosen from
hydrogen
the phenyl or aryl groups comprising from 5 to 20 carbon atoms,
the silyl groups substituted by alkyl groups comprising from 1 to 20 carbon atoms,
the saturated or unsaturated, linear, branched or cyclic alkyl groups comprising from 1 to 20 carbon atoms,
the aryl, silyl or alkyl groups, as defined previously, moreover linked as a bridge to another ^{Ra}CpH, identical or different from the first, or linked to another position of the initial ^{Ra}CpH, thus forming one or more side rings, in particular indene and fluorene,
the aryl, silyl or alkyl groups, optionally bridging or cyclizing as defined previously, moreover substituted by one or more identical or different groups, chosen from the following functions: halogen, alcohol, alkoxy, phenol, phenoxy, thiol, thioether, sulphone, sulphoxide, carboxylic acid, sulphonic acid, amine, imine, imide, amide, phosphine, phosphite, carbene in particular 1,3-bis(alkyl)imidazol-2-ylidene,
a second ligand or ligand precursor of formula ^{Rb}CpH the meaning of which is the same as that stated above for ^{Ra}CpH, provided that ^{Ra}CpH and ^{Rb}CpH are different,
at least one rare earth salt of formula MX₃, in which M represents a rare earth element chosen from scandium ₂₁Sc, yttrium ₃₉Y, or a lanthanide chosen from lanthane ₅₇La, cerium ₅₈Ce, praseodymium ₅₉Pr, neodymium ₆₀Nd, promethium ₆₁Pm, samarium ₆₂Sm, europium ₆₃Eu, gadolinium ₆₄Gd, terbium ₆₅Tb, dysprosium ₆₆Dy, holmium ₆₇Ho, erbium ₆₈Er, thulium ₆₉Tm, ytterbium ₇₀Yb, lutetium ₇₁Lu, and in which X is a monocharged anion associated with the cation of the element M, X being chosen from the carboxylates, the alcoholates, the hydrides, the phenates, the amides, the diketonates, the halides, the (organo)phosphates, the phosphonates, the phosphinates, the nitrates, the sulphates, the sulphonates, in particular chosen from the versatate, borohydride, or tert-butylate ion,
at least one dialkyl magnesium compound of formula R—Mg—R′ in which R and R′, identical or different, represent cyclic or non-cyclic, substituted or unsubstituted, linear or branched aryl or alkyl groups, comprising from 1 to 20 carbon atoms,
ethylene,
a second olefin, in particular chosen from
the conjugated dienes, in particular butadiene, isoprene, myrcene or ocimene,
the alpha-omega-dienes, in particular 1,5-hexadiene,
the aromatic vinyl compounds, in particular styrene, paramethylstyrene, alphamethylstyrene,
the alpha-olefins, in particular propene, butene, hexene, and octene,
and makes it possible to obtain, by the Chain Shuttling Catalysis process, long-chain dialkyl magnesium compounds the chains of which are copolymers of ethylene and another monomer chosen from the olefins named above.

20. Process according to claim 1, comprising one or more additional stages making it possible to prepare polyethylenes having a terminal function, in particular chosen from
the primary linear fatty alcohols PE-OH obtained by oxidation, in particular with oxygen, of the polymerization products,
the PE-CH═CH₂ α-olefins by thermal decomposition of the polymerization products,
the PE-COOH acids, by reaction between CO₂ and polymerization products,
the PE-SH thiols by a synthesis comprising three stages,
a first stage comprising the preparation of the polymerization products,
a second stage comprising the manufacture of dithiocarbamate compounds by reaction between disulphiram (tetraethylthiurame sulphide) and the polymerization products obtained above,
a third stage comprising the reduction of the dithiocarbamates obtained in the previous stage,
the iodine compounds PE-I by reaction between diiodine I₂ and polymerization products,
the azides PE-N₃ by a synthesis comprising three stages,
a first stage comprising the preparation of the polymerization products,
a second stage comprising the manufacture of an iodine compound by reaction between diiodine I₂ and the products originating from the polymerization obtained above,
a third stage comprising the reaction of sodium azide with the iodine compounds formed in the second stage,
the amines PE-NH₂ by a synthesis comprising four stages,
a first stage comprising the preparation of the polymerization products,
a second stage comprising the manufacture of an iodine compound by reaction between diiodine I₂ and the products originating from the polymerization obtained above,
a third stage comprising the reaction of sodium azide with the iodine compounds formed in the second stage,
a fourth stage comprising the reduction of the azides obtained in the third stage,
the colouring functions, in particular the PE porphyrin dyes by a synthesis comprising four stages,
a first stage comprising the preparation of the polymerization products,
a second stage comprising the manufacture of an iodine compound by reaction between diiodine I₂ and the products originating from the polymerization obtained above,
a third stage comprising the reaction of the sodium azide with the iodine compounds formed in the second stage,
a fourth stage comprising the reaction of the azides formed in the third stage with a porphyrin functionalized by an alkyne function in the presence of copper bromide (I),
the fluorescent labels, in particular of the rhodamine, PE-tagged type by reaction between the rhodamine B base and polymerization products,
the PE-RAFT reversible addition and fragmentation transfer agents, in particular the compounds of the following general formula 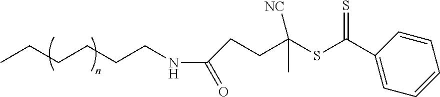
in which
n represents the average —CH₂—CH₂— chain formation number greater than 1, in particular from 20 to 200,
by reaction between amino-functionalized polymerization products PE-NH₂ defined above and the dithiocarbonyl product of the following general formula: [chemical structure]
